(19) United States
(12) Patent Application Publication
(10) Pub. No.: US 2009/0204418 A1
(43) Pub. Date: Aug. 13, 2009

(54) Computerized system for demonstrating a fair settlement proposal

(76) Inventor: James F. Ring, Providence, RI (US)

Correspondence Address: James F. Ring;c/o Chu, Ring & Hazel, LLP, 241 A Street, Boston, MA, 02210, US

(21) Appl. No.: 12/322,736

(22) Filed: Feb. 6, 2009

Related U.S. Application Data
(60) Provisional application No. 61/065,047, filed on Feb. 7, 2008.

(51) Int. Cl. G06Q 99/00

(52) U.S. Cl. 705/1

(57) ABSTRACT

The invention that is the subject of this Disclosure consists of a computerized method whereby a party that is involved in a dispute can either secure a resolution of that dispute on terms that that party deems to be acceptable or be in a position to easily and credibly demonstrate to third parties that it has acted fairly in connection with that dispute. It involves the use of a computerized system that combines aspects of a sealed-bid mechanism with a commitment mechanism to facilitate convergence of the parties on a settlement that is focal and that they consider fair. It includes an option for final-offer arbitration in the event that the parties fail to achieve a settlement prior to a fixed deadline. Unlike mediation and traditional sealed-bid mechanisms, the structure of the system gives the initiating party a strong incentive to make a fair and reasonable proposal at the outset of the process. In addition, it deprives the other party of any incentive or excuse for failing to do this prior to the deadline.

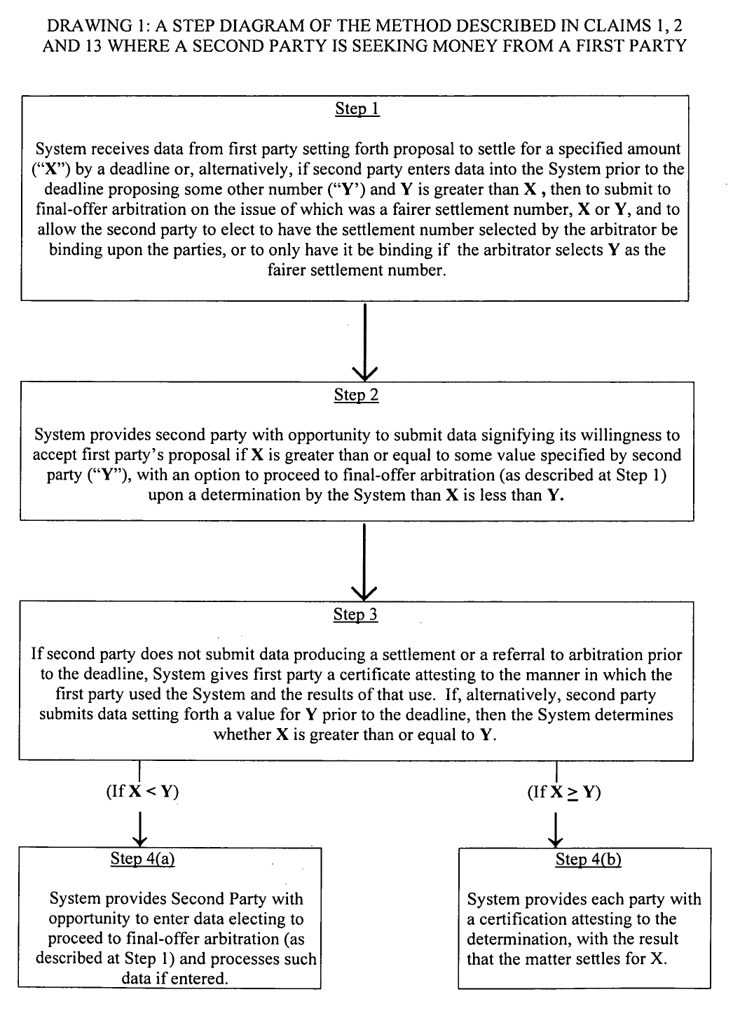

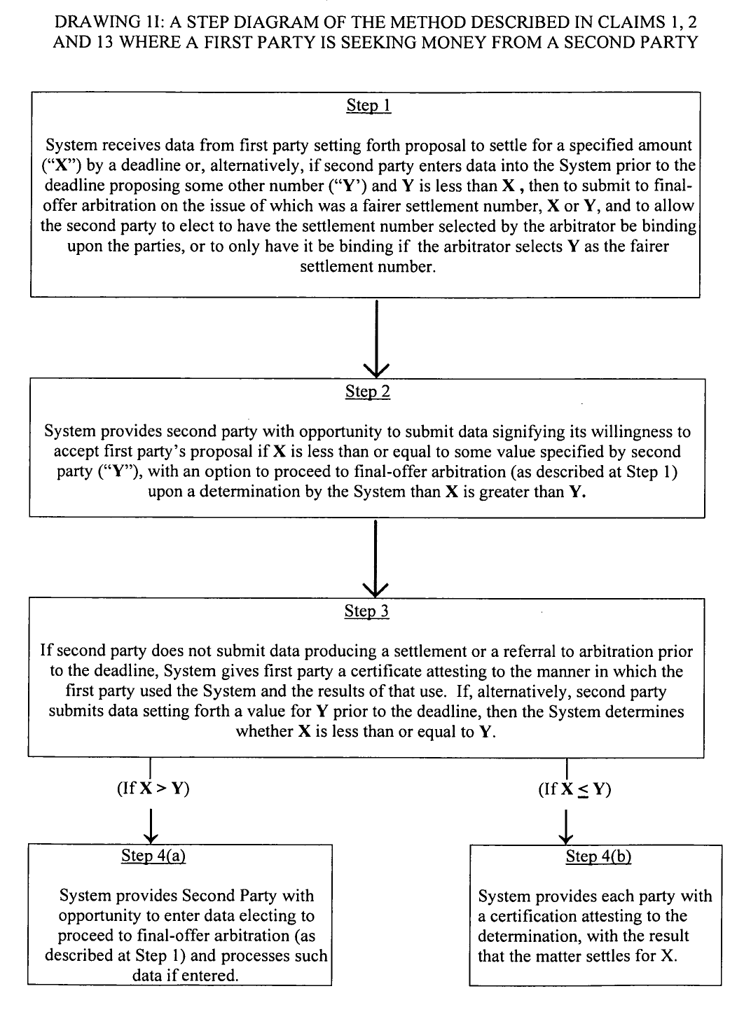

### CROSS REFERENCE TO RELATED APPLICATIONS

This application claims priority to U.S. provisional patent application No. 61/065,047, filed Feb. 7, 2008 by the present inventor, the entire Disclosure of which is incorporated herein by reference. This application is related to U.S. patent application Ser. No. 11/066,047, filed Feb. 24, 2005 by the present inventor, the entire Disclosure of which is also incorporated herein by reference.

A portion of the Disclosure of this patent document constitutes material which is subject to copyright protection. The copyright owner has no objection to the facsimile reproduction by anyone of the patent document or patent Disclosure, as it appears in the Patent and Trademark Office patent file or records, but otherwise reserve all copyright rights whatsoever.

### STATEMENT REGARDING FEDERALLY FUNDED RESEARCH OR DEVELOPMENT

(Not applicable.)

### REFERENCE TO A SEQUENCE LISTING

(Not applicable.)

### BACKGROUND OF THE INVENTION

(I) Field of the Invention

The present invention is concerned generally with the field of bargaining and dispute resolution, and specifically with providing a method whereby a party that is involved in a dispute may enter data into an online computerized system that will either produce a resolution of that dispute on terms that that party deems to be acceptable or allow that party to easily and credibly demonstrate to third parties that it has acted fairly in connection with that dispute. The operational aspects of will be most readily understood by computer scientists and the functional aspects will be most readily understood by parties who are experienced in the use and provision of escrow services and in providing assistance to parties who are involved in disputes, such as attorneys. The principles that underlie the invention will be most readily understood and appreciated by game theorists, economists, and strategic analysts.

(II) Background Art

The invention that is the subject of this Disclosure has particular application and utility in situations—such as disputes arising within the context of e-commerce transactions—where a party or group of parties (a “first party”) is involved in a dispute with another party or group of parties (a “second party”) that has or may cause damage to the first party's reputation in the eyes of a third-party (such a third party or group of third parties is hereinafter referred to as an “Audience”). For example, within the context of e-commerce transactions, a first party that sells an item to a second party via the use of an e-commerce website (such as eBay) may find itself subjected to “negative feedback,” i.e., the second party may post negative commentary about the first party on the public pages of the e-commerce website with respect to the transaction in question, damaging the first party's reputation in the eyes of an Audience. Moreover, that negative feedback may, in combination with other negative or positive feedback that has been posted about that first party, be factored into a reputation rating (typically signified by a numerical score) concerning the first party. (Such reputation-rating scores are commonly calculated by the administrators of e-commerce sites and by third-party reputation-rating services and then made available online to the general public.) The negative commentary and/or reputation rating can then be taken into account by an Audience as it considers whether and under what circumstances to deal with the first party. Such negative commentary is often calculated to cause, and does cause, substantial damage to the first party's reputation and ability to engage in future transactions, causing losses to the first party that may substantially exceed the amount in controversy in the underlying dispute. See, e.g., Ghose, A., Ipeirotis, P. G. and Sundararajun, A. (2006) “The Dimensions of Reputation in Electronic Markets.” Working Paper CeDER—06-02, New York University, pp. 1-5.

As shall become evident in the pages that follow, the problem that the present invention serves to address concerns how a first party involved in a dispute with a second party can, without causing prejudice to its own interests, make a credible demonstration to an Audience that it has acted fairly with respect to the second party, including in situations where the Audience is disinterested in—or incapable of becoming informed about or passing judgment on—the merits of the underlying dispute. For purposes of setting forth the background of the invention that is the subject of this Disclosure, this section of the Disclosure:
(1) briefly reviews the historical recognition that Audiences, and the development of methods whereby a party engaged in a conflict can communicate meaningful information to an Audience, have always played a significant role in the resolution of conflict;
(2) describes the manner in which the problem addressed by the present invention manifests itself within the context of e-commerce disputes, as this allows for a relatively simple illustration of the problem as well as the felt need for a solution and the difficulties associated with developing such a solution;
(3) briefly considers how the problem manifests itself within other contexts, such as in disputes between two parties in which one party has filed or threatened to file a lawsuit for monetary damages against the other party;
(4) considers certain academic work within the field of game theory that serves to suggest how such problems can be addressed within a different and more narrow class of disputes—between two parties over how to divide property—through an undertaking by one party to subject itself to a set of rules with respect to a bargaining process;
(5) briefly reviews the manner in which parties have found ways in which to subject themselves to such sets of rules within the context of disputes between joint owners of property;
(6) notes that the ability of a party to credibly subject itself to such a set of rules and induce its adversary to respond in a meaningful may be enhanced or—in some cases—only become possible through the use of a properly designed process carried out by a computerized machine; and
(7) notes the current existence of two computerized online bargaining mechanisms, one of which was invented and one of which was co-invented by the present inventor, and each of which (i) is presently fully operational, (ii) can be used by first parties to unilaterally commit to certain bargaining protocols, and (iii) can be used by a party to make demonstrations that it has acted fairly to certain Audiences with respect to certain types of claims, but which do not serve to fully address the problem for which the present invention provides a complete solution.

### E.1 Historical Recognition of the Role Played by Audiences and Information Technology in the Resolution of Conflict

Audiences have played a role in conflict resolution throughout history, and their capacity to influence the behavior of parties involved in a conflict has frequently been cited as having played a significant role in the evolution of civilization itself. See, e.g., Hammerstein, P. (Ed) (2003) Genetic and Cultural Evolution of Cooperation. (MIT Press: Cambridge, Mass.) For example, it is not unreasonable to suppose that, in prehistoric times, a member of a tribe that was perceived by other members of that tribe (i.e., an Audience) to have dealt with a given conflict in a manner that was adverse to the tribe's interests—such as by responding to a disagreement with a fellow tribe member in an excessively violent manner, or responding to an outside threat in an excessively docile manner—would have either been put to death or cast out into the wilderness, depriving that member of an opportunity to reproduce and pass along its genes.

Audience issues have continued to play a significant role in conflict resolution as history has unfolded, a role that—in the view of many commentators—has been substantially expanded by the ongoing introduction of new communication technologies allowing for ever-increasing amounts of information to be delivered to Audiences throughout the world with ever-increasing speed. The potential impact that these technological advances would have on parties engaged in conflict, and on Audience issues in relation to same, was already fully evident by the beginning of the 20^{th} Century:
Gradually, everything that happens in the world is coming to be of interest everywhere in the world, and, gradually, thoughtful men and women everywhere are sitting in judgment upon the conduct of all . . . . The spread of popular education; the enormous increase in the production and circulation of newspapers and periodicals and cheap books; the competition of the press, which ranges the world for news; the telegraph, which carries instantly knowledge of all important events everywhere to all parts of the world . . . —all these are creating an international community of knowledge and interest, of thought and feeling . . . .
The chief force which makes for peace and order in the community of individuals is not the police officer, with his club, but it is the praise and blame, the honor and shame, which follow observance or violation of the community's standards of right conduct. In the new era that is dawning of the world's public opinion we need not wait for the international policeman, with his artillery, for, when any people feels that [one who is responsible to them] has done a shameful thing . . . theirs will be the vengeance and they will inflict the punishment.
Root, Elihu (1914) “Undelivered Address Accepting the Nobel Peace Prize,” appearing in Elihu Root's Addresses on International Subjects, edited by Robert Bacon and James B. Scott (Cambridge: Harvard University Press, 1916) pp. 153-174 (a copy of this address is presently available online at http://nobelprize.org/nobel_prizes/peace/laureates/1912/root-lecture.html).

While methods for facilitating the conveyance of information to Audiences about specific conflicts and the manner in which those conflicts are being conducted by the involved parties has continued to rapidly develop, there has been no corresponding progress in the development of methods by which a party involved in a conflict might be able to credibly demonstrate to an Audience that it has acted fairly with respect to its adversary—precisely the sort of information that many parties would like to convey in order to preserve their reputation and bring public pressure to bear upon their adversary. To the contrary, ancient societies were arguably much more productive than our own in developing methods whereby a party involved in a conflict could make such demonstrations. For example, and as was noted by Schelling (1960), the methods developed in ancient times included offering to exchange hostages in order to guarantee the maintenance of cease-fire arrangements, proposing agreements under which each party would agree to suffer the presence within its territory of spies working on behalf of the other in order to reinforce trust, and—as a more basic example—offering to drink wine from the same glass tendered to an adversary in order to demonstrate the absence of poison. Schelling, Thomas C. (1960) The Strategy of Conflict. (Cambridge, Mass.: Harvard University Press), p. 20. These sorts of actions shared an important feature in common: they carried within themselves evidence of their own intrinsic fairness and credibility, with the result that a party proposing such an arrangement could demonstrate both to an adversary and to an Audience—even to an Audience that had no way of discerning who was at fault for the underlying conflict—that the party making that proposal had undertaken to treat its adversary in a fair and reasonable manner.

With the exception of certain methods developed and employed during the Cold War (such as the practice of leaving one's own cities completely exposed to a nuclear attack in order to demonstrate the absence of any incentive to make a first strike upon an adversary), and with the exception of certain methods as described in subsections E.4, E.5 and E.7 below, the modern world has not brought forth any methods for demonstrating that a party has acted in a fair manner that are equivalent to those developed and utilized in ancient times. For example, although the development of modern legal systems by sovereign states may be viewed as a progressive development insofar as a party can resort to such systems as an alternative to engaging in violence against other subjects of that state, no Audience would consider a party's participation in a lawsuit (as opposed to resorting to violence or to some other unlawful means of advancing one's position in a given conflict) as demonstrating that that party was treating its adversary in a fair or particularly productive manner. Two parties that are subject to the same sovereign power are effectively compelled by the state, if they wish to seek to prevail over their adversary with respect to a given conflict, to resort to the legal system offered, organized and administered by that sovereign power—a compulsion that is ultimately backed up by the power of a gun. And legal systems do not in any sense serve to deprive either party of an opportunity to treat an adversary in a manner that a fully informed Audience would view as fundamentally unfair. Resort to a legal system simply changes the forum and the methods by which one party can seek to extract concessions and advance its own interests with respect to an adversary.

Some may argue that, in recent decades, our generation has made great progress in developing methods that are capable of ushering in a new era of fair and cooperative conflict resolution. For example, it has been noted that “Courts have invested much time, money and psychic energy in developing ADR [Alternative Dispute Resolution] procedures within the courts. An entire industry has grown up of ADR providers, and many of these derive their livelihood from court-ordered ADR. Many others provide private ADR in connection with litigation. Can it be true that these procedures have no effect?” Alexander, J. C. (1999) “The Administration of Justice in Commercial Disputes: Developments in the United States.” The Administration of Justice in Commercial Disputes. Canadian Institute for the Administration of Justice. (Montréal: Thémis, 1999), p. 34. The short answer to that question, arrived at both by the author of that article and by the authors of other credible studies (see, e.g., Kakalik, J. (1996). An Evaluation of Mediation and Early Neutral Evaluation Under the Civil Justice Reform Act (California: RAND Institute for Civil Justice.)) is that the answer appears to be “yes.” (See also, in this regard, the discussion infra at p. 14.) It is fair to say that prominent members of each succeeding generation since the late nineteenth century have professed to have discovered a “new” cure for conflict, a cure that has—in virtually all instances—consisted of little more than a suggestion that parties can or should be persuaded to “transcend” conflict and the pursuit of selfish interests through the use of methods such as mediation. Yet, as was noted by Elihu Root in the above-referenced address, such suggestions are clearly lacking in credibility and—as a result—often serve to undermine public confidence in conflict resolution systems in general:
The apparent simplicity of the subject is misleading. Recognition of the horrors of war and the blessings of peace, acceptance of the dogma “War is wrong and to keep the peace a duty,” are so universal that upon the surface it seems only necessary to state a few incontrovertible truths and to press them upon the attention of mankind, in order to have war end and peace reign perpetually.
Yet the continual recurrence of war and the universally increasing preparations for war based upon expectation of it among nations all of whom declare themselves in favor of peace, indicate that intellectual acceptance of peace doctrine is not sufficient to control conduct, and that a general feeling in favor of peace, however sincere, does not furnish a strong enough motive to withstand the passions which lead to war when a cause of quarrel has arisen. The methods of peace propaganda which aim at establishing peace doctrine by argument and by creating a feeling favorable to peace in general seem to fall short of reaching the springs of human action and of dealing with the causes of the conduct which they seek to modify . . . . The mere assemblage of peace loving people to interchange convincing reasons for their common faith, mere exhortation and argument to the public in favor of peace in general fall short of the mark.
They are useful, they serve to strengthen the faith of the participants, they tend very gradually to create a new standard of conduct, just as exhortations to be good and demonstrations that honesty is the best policy have a certain utility by way of suggestion . . . . But the mere repetition of the obvious by good people of average intelligence, while not without utility and not by any means to be despised as an agency for peace, nevertheless is subject to the drawback that the unregenerate world grows weary of iteration and reacts in the wrong direction . . . . To deal with the true causes of war one must begin by recognizing as of prime relevancy to the solution of the problem the familiar fact that civilization is a partial, incomplete, and, to a great extent, superficial modification of barbarism.
Root, Elihu (1914), at p. ______ (cited supra at p. ______).

As we approach the centennial of Elihu Root's authorship of the above address, the ability of parties to convey information to Audiences through technological advances—advances that Root described as a critical component of any solution to the problem of conflict—has reached a level that was unimaginable in his time. The next sub-section of this Disclosure considers the extent to which the manner in which such technology has been used in the context of e-commerce disputes may serve to suggest alternative methods for resolving and managing conflict, as generally anticipated and hoped for by Root (who was, ironically, ultimately prevented from delivering the above-cited address due to the outbreak of World War I).

### E.2 Summary of the Problem as Manifested in the E-Commerce Field

A second party that is unhappy with an online transaction is frequently unable to obtain relief from a court, or to use a legal system as a mechanism to extract a fair settlement from the first party, because cost and distance make a lawsuit impractical. Allowing such a second party to submit negative feedback that adversely affects the online reputation of the first party—damaging the first party's reputation in the eyes of an Audience and thus undermining the first party's ability to engage in other e-commerce transactions with members of that Audience—facilitates the resolution of disputes by creating an incentive to settle that would otherwise not exist.

Companies that administer e-commerce sites typically (a) allow negative feedback from second parties to be posted on their sites and/or factored into public online reputation-rating systems and (b) will not remove or discount that feedback without the consent of the second party. This, in turn, often facilitates a resolution of the underlying dispute, but at a cost because these kinds of feedback systems can be misused.

For example, a second party may submit negative feedback, or refuse to withdraw it in the face of a fair settlement offer, in an effort to extract unwarranted concessions or accommodations from the first party. As is discussed in further detail below, administrators of e-commerce sites are understandably reluctant to get involved in examining or passing judgment on the merits of feedback. Moreover, the same cost and distance factors that frequently preclude a second party from commencing a lawsuit against the first party typically preclude the first party from commencing a court action for libel or commercial defamation against the second party with respect to the feedback in question. Thus, a first party seeking relief from negative feedback has historically been left with no option other than to try to bargain with the second party in an effort to secure a withdrawal of the negative feedback. Yet, in many cases, this simply provides the second party with an opportunity to demand concessions and outcomes that are self-serving or extortionate, delaying and in many cases precluding a fair settlement.

First parties that are faced with this problem frequently argue that the problem could and should be solved by having the company administering the e-commerce site (or reputation-rating system) examine the merits of the underlying dispute and remove or discount the feedback upon a determination that the feedback was inaccurate or unfair. However, this proposed “solution” has not been adopted for two fairly straightforward reasons. First, if such an administrator were to take on the task of seeking to ensure the accuracy or fairness of negative feedback, it would have to incur the cost of investigating the facts underlying the dispute and the positions of the parties with respect to same, substantially increasing its operating costs and requiring it to charge higher fees for the use of its system. The second justification is that editing or removing feedback for any reason other than a clear violation of a stated policy against offensive language (such as profanity or death threats) would place the administrator on a slippery slope where, if it edited or discounted a given piece of feedback about one first party, it would be subject to claims by other first parties that it should have done the same in some other particular case, exposing it to legal claims.

In an effort to address the demand for a solution to this problem without having to become involved in investigating and passing judgment on the merits of negative feedback, companies that administer e-commerce sites (and reputation-rating systems) have from time to time instituted variations of two distinct polices in an effort to mitigate the problem. Variations of both of these policies were, for example, historically offered to users of eBay. (See generally, with regard to the resolution of disputes arising within the context of eBay transactions, Edwards, L. and Theunissen, A. (2007) “Creating Trust and Satisfaction Online: How Important Is ADR?: The eBay Experience.” Web Journal of Current Legal Issues, 2007 5 Web JCLI (available online at http://webjcli.ncl.ac.uk/2007/issue5/edwards5.html).) One of these two policies involved allowing first parties to respond to negative feedback from a second party by submitting retaliatory negative feedback about the second party, thus intimidating second parties from submitting negative feedback and giving first parties a weapon that they could use within the context of bargaining over an agreement for feedback withdrawal. This policy was abandoned by eBay in the Spring of 2008, when it instituted new policies under which negative feedback could continue to be posted by a buyer with respect to a seller, but could no longer be posted by a seller with respect to a buyer (for the stated reason that the prospect of retaliatory feedback was intimidating buyers from posting legitimate criticisms of sellers, eroding the accuracy of the reputation ratings appearing on its site and thus undermining buyer confidence within that market). This change to eBay's historical policy was vigorously protested by sellers, many of whom called for worldwide boycotts of eBay in response to this change, arguing that the demise of retaliatory feedback would remove any restraint upon the submission of extortionate feedback by buyers. (See generally, with regard to the positions taken by eBay and its critics with respect to these changes to eBay's feedback policies, the numerous archived news articles about those events from the Spring of 2008 that may be accessed at http://www.auctionbytes.com.)

The other policy that eBay offered in an effort to mitigate the problem addressed by the present invention was also abandoned by eBay in the Spring of 2008. However, the abandonment of this second policy generated much less controversy and comment than the elimination of retaliatory feedback, presumably because—unlike retaliatory feedback and for reasons discussed in further detail below—it did not provide a device that parties could use in a strategic way to fend off or obtain bargaining leverage with respect to negative feedback. Yet this second policy, as described below, is deserving of attention in considering the background of the present invention, as it illuminates certain features of the underlying problem that should be taken into account in considering the solution that the present invention to serves to offer.

Under this second policy, first parties seeking a removal or a discount of negative feedback would be referred to a third-party mediation service such as the mediation service offered at http://www.squaretrade.com. Under this approach to the problem, the first party was given the option of paying a fee to the mediation service, which if paid would cause the mediation service to invite the second party to participate in a mediation at which the parties could attempt to work out their differences, hopefully resulting in an agreement by the second party to authorize the administrators of the e-commerce site (or reputation-rating system) to remove or discount the negative feedback (an agreement that could then be transmitted to the administrator via online data submitted by the mediation service, resulting in an automatic discount of the negative feedback).

From the perspective of a first party, attempting to use mediation as a method for securing a removal of negative feedback is problematic on several levels. As an initial matter, and as has been recognized in literature concerning the strategic management of conflict, signifying to one's adversary that one is willing to engage in a mediation process will under most circumstances be correctly interpreted by one's adversary as a signal of weakness, because it signifies a willingness to reconsider one's previously stated position with respect to a dispute, and to compromise and grant further concessions. (See generally, in this regard, Schelling (1960), pp. 34-35 (cited supra at p. 6).)

In addition, although mediation may facilitate a settlement when two parties each have a strong desire to settle or have arrived at a point (such as the eve of a trial) where each has a strong incentive to settle in order to address an imminent risk, there is no persuasive evidence that mediation “causes” settlements, nor is there any reason to suppose that a mediation process would be of any use in a context where one party faced no risk of serious loss (as was the case for second parties using eBay once retaliatory feedback was no longer an option for first parties):
Proponents . . . contend that cases settle “because” of mediation. The evidence for this assertion is that the cases settle shortly after mediation. I find this argument unpersuasive. Most cases settle; among the perennial problems of negotiation are knowing when both parties are willing to negotiate seriously, and making concessions without signaling weakness. It is helpful to have some outside event to signal the start of serious negotiations and to relieve the parties of the responsibility for making serious concessions . . . . Thus cases may settle right round the mediation because the mediation is the accepted signal that serious negotiations can begin. Mediation may not be the cause of the settlement, but just the dinner bell . . . .
Alexander, J. C. (1999) pp. 34-35 (cited supra at p. 8).

In cases where at least one party has no incentive to settle, there is no basis for supposing that mediation will produce a settlement, and every reason to expect that the mediation process will simply become a platform whereby a party that has no incentive to settle can make excessive demands and seek unwarranted concessions.

Notwithstanding these limitations on the ability of third-party mediation services to contribute to a solution to the underlying problem, one aspect of the policies under which first parties were referred to these services by e-commerce administrators serves to point the way to an alternative solution. Specifically, these policies typically included a feature under which, if the second party failed to respond to the mediation service provider's invitation to participate in mediation and the mediation service provider transmitted data confirming that failure to the administrator of the e-commerce site, then the second party's negative feedback would be automatically discounted.

It will be appreciated that such an action by an administrator would not be based (and could not credibly be claimed to have been based) upon an investigation or adjudication by the administrator with respect to the underlying merits. To the contrary, the administrator's discounting of the negative feedback would be solely attributable to the second party's failure to participate in a process that the administrator deemed to be fair. Under such circumstances, the administrator of an e-commerce site or reputation-rating service could justify its provision of relief to the first party while at the same time remaining willfully ignorant of the merits of the underlying dispute between the parties, thus protecting itself from excessive costs and legal exposure.

It will be noted that a first party's ability to secure relief in this manner would be entirely dependent upon the second party's failure to respond to the invitation to participate in the third-party process. And, since the second party could easily deprive the first party of such relief by simply accepting the invitation and then using the third-party process as a platform for posturing and demanding unwarranted accommodations, a first party that initiated such an invitation would have no basis for confidence that the issuance of the invitation would result in a removal or discount of the negative feedback, even in cases where the evidence that the first party could present at the mediation would leave no doubt in the mind of any objective observer that the negative feedback was entirely inaccurate and unfair.

Conversely, it will also be noted that this policy could lead to a removal of entirely legitimate negative feedback in cases where the second party had ample evidence to support its position on the merits. Specifically, a second party might have any number of rational reasons for declining to participate in a mediation process, including a fear of signaling weakness, a well-founded belief that the first party would not make a fair proposal within the context of the mediation process, or a concern that the third-party mediator might be biased.

However, notwithstanding the fact that a mediation process might devolve into useless posturing by one or both of the parties, and notwithstanding the fact some second parties might have numerous rational grounds for declining to accept an invitation to participate in mediation, e-commerce administrators considered the attributes of a mediation process to be sufficiently fair so as to justify a discount of negative feedback if a second party refused to accept an invitation to mediation. This approach, in turn, points the way to a more general solution: if a dispute resolution process had attributes such that, unlike mediation, a second party had no rational grounds for declining an invitation to participate in that process, then a discount of negative feedback based upon a second party's failure to participate in that process would be even easier to justify. Moreover, if the attributes of the dispute resolution system were such that neither party had any rational basis for failing to use it (as where—unlike mediation—its use could not be interpreted as a signal of weakness by either party, and where it could not be efficiently used by either party as a platform for posturing and demanding further concessions), then that system would provide a full and complete solution to the underlying problem from the perspective of all parties, including the first party, the second party, the administrator of the e-commerce site or reputation-rating service, and the Audience at large.

On a related subject, and before turning to the next section of this discussion on the background of the present invention, it should be noted that there is some academic literature referencing the possible use of computerized versions of symmetrical sealed-bid mechanisms to seek a resolution of e-commerce disputes. See, e.g., Gabuthy, Y. and Marchand, N. (2004) “Does Resorting to Online Dispute Resolution Promote Agreements? Experimental Evidence” a copy of which is available online at http://ideas.repec.org/p/wpa/wuwpeex/0402002.html. However, for the reasons set forth in Gabuthy and Marchand's article—which concludes that such symmetrical sealed-bid mechanisms tend to “chill” bargaining by creating “incentives for individuals to misrepresent their true valuations,” thereby discouraging settlements and creating inefficiencies—it would be difficult for an administrator of an e-commerce site (or reputation-rating service) to justify a discount of negative feedback on the basis of a second party's failure to accept an invitation to use a symmetrical sealed-bid system. As is evident from the academic literature concerning symmetrical sealed-bid systems, a second party (as well as a first party) may rationally decline to use such a system on several grounds, including:
(1) that—as with a mediation process—expressing a willingness to participate in the process might be viewed as a signal of weakness, i.e., of a willingness to consider compromise or to reconsider a publicly stated position with respect to the dispute;
(2) that—as with a mediation process—one might inadvertently propose to one's adversary, and thus wind up with, a resolution less favorable to oneself than some other resolution that one's adversary might have ultimately been willing to grant; and
(3) that if—in order to fend off an outcome as described at paragraph (2) above—one party submitted a sealed-bid containing a proposal less favorable to its adversary than the submitter would ultimately be willing to grant, and if a settlement was not achieved as a result, then the submitting party would be foreclosed from revising its proposal so as to put forth a more forthcoming offer because at that point the process for submitting sealed-bids would have come to an end.

### E.3 Manifestations of the Problem Outside of the E-Commerce Field

Even in cases where it is possible for a party involved in a dispute to justify and bear the expense of commencing or responding to a lawsuit and pursuing it all the way through trial and any subsequent appeal, there are many instances where that party will suffer harm to its reputation pending the completion of such a formal legal process, as where the prudence and necessity of engaging in such a process may be called into question by an Audience to whom that party is answerable. A party that finds itself in such a position and wishes to demonstrate that it has acted fairly and reasonably in connection with the underlying dispute—thus shifting the blame for the ongoing lawsuit to the other side—is faced with a paradox similar to that which is faced by parties involved in e-commerce disputes and in virtually all forms of bargaining. Specifically, if a party involved in a bargaining process wishes to demonstrate to an Audience that it is bargaining in a fair manner, it is generally required to demonstrate that it has proposed a fair settlement or outcome to the other side. Yet, even if it makes a settlement proposal that an objective party that was fully familiar with all the facts and circumstances would view as reasonable, the party that is on the receiving end of the proposal can—by simply rejecting the proposal—raise questions about the reasonableness of the proposal in the minds of an Audience that is not fully familiar with the underlying merits. Moreover, and as was noted with respect to e-commerce disputes, the proposal itself may be viewed as a sign of weakness, and as a starting point from which to try to extract further concessions, causing substantial prejudice to the proposing party's bargaining interests and further delaying a fair settlement.

The major difference between disputes arising out of e-commerce transactions and disputes that are the subject of real-world litigation is that each of the parties involved in litigation has, as bargaining leverage, the prospect of an eventual trial on the merits in the event that the matter is not settled. This bargaining leverage allows virtually all litigants in the United States (by most estimates more than 90%) to eventually settle their cases on mutually acceptable terms. See, e.g., Spier, K. E. (1992) “The Dynamics of Pretrial Negotiation.” Review of Economic Studies, Vol. 59, No. 1, pp. 93-108; Williams, G. R. (1982) Legal Negotiations and Settlement. (St. Paul Minn.: West Publishing). However, studies suggest that the vast majority of cases that settle (80% or more) do not settle until the parties reach a point where they are within thirty days of trial, i.e., for a period of years. Id. In the interim, many of these parties find themselves in a position where they are unable to make a credible demonstration to any relevant Audience that they have acted—or are acting—in a manner that is reasonable and fair, or that the failure of the parties to achieve a settlement is solely attributable to unreasonableness on the part of the other side.

### E.4 Identification of Principles Relevant to the Problem in the Academic Field of Game Theory

Academic studies of various bargaining processes have recognized the difficulties faced by a bargainer that is attempting to credibly demonstrate that it has acted in a fair manner, and these studies suggest that there are ways in which parties can do this within a relatively narrow class of disputes: disputes between joint owners of property (such as partners, shareholders, or married couples) over how to divide the property or effect a buy-out of one party's interests by the other. In so doing, those studies have identified certain principles that are applicable to making such demonstrations in other types of disputes.

For example, game-theoretic studies have considered the position of two parties engaged in a bargaining process over how to divide up a cake. Within such contexts, one party can unilaterally volunteer to be the “cutter” in a game of “I cut—you choose.” Under the rules of this game, the cutter cuts the cake into two pieces in whatever manner it deems appropriate, and then cedes to the other party the right to select either piece. Given the rules of the game, self-interest requires the cutter to cut the cake in a manner such that the cutter will be indifferent to which piece is selected by its adversary. The cutter's optimal strategy, in the pursuit of its own best interests, is to cut the cake in a manner that is fair—if it fails to do so it may suffer harm as a direct result. And, given the rules of the game, this fact is self-evident to the cutter's adversary (and would also be self-evident to any relevant Audience). Moreover, and importantly, if the cutter's adversary fails to take advantage of the opportunity to select a piece, the adversary may properly be viewed (and should be viewed by an Audience) as having acted in an irrational or unfair manner.

Thus, game-theoretic studies of “I cut—You Choose” provide insight into the design of bargaining systems under which one party can credibly demonstrate to an adversary and/or to an Audience that it has acted in a demonstrably fair manner and/or committed itself to a fair outcome to the underlying dispute that the other party cannot rationally reject. These studies suggest that a party may make such a demonstration if it can find a way to commit itself to abide by a process and a set of rules or protocols under which it becomes self-evident to all concerned that proposing a fair solution has become its optimal strategy. See generally, with regard to cake-cutting games, Brams, S. J. and Taylor, A. D. (1996) Fair Division: From Cake-Cutting to Dispute Resolution (New York: Cambridge University Press), chpt. 1, and Brams, S. J. and Taylor, A. D (1999) The Win-Win Solution. Guaranteeing Fair Shares to Everybody (New York: W. W. Norton), chpt. 4.

### E.5 The Historical Use of Commitment Mechanisms in Applying Game-Theoretic Principles to Disputes Over Jointly-Owned Property

Having noted that a party involved in a dispute over how to divide up jointly-owned property might be able to advance its own interests if it could find a way to credibly commit itself to abide by a given set of bargaining rules or protocols, it is appropriate to note that there are methods by which this can readily be done. Specifically, parties entering into joint ownership agreements (such as a partnership agreement, joint venture agreement, shareholder agreement, or prenuptial agreement) can and often do contractually bind themselves to abide by certain bargaining protocols that are directly analogous to a game of “I Cut—You Choose.” Contractual clauses that impose such rules upon the parties are generally referred to as “Buy-Sell Clauses.” Such clauses typically provide that, upon the occurrence of certain conditions, one party may or must propose a value for the jointly owned property at which it would be willing to either sell its share to the other side or, alternatively, buy out the other side's share, ceding to the other side the option of electing to either buy or sell on the basis of that proposed value up to a fixed deadline.

For purposes of considering the background of the present invention, it is important to note that, in addition to using a pre-existing contractual arrangement to commit oneself to the use of a buy-sell arrangement under certain conditions, it is not uncommon for a party involved in dysfunctional joint ownership relationship to commit itself to such a process unilaterally. In order to do so, a party simply needs to (a) disclose its valuation to the other party, and (b) formally offer to either buy or sell at the stated price, at the election of the other party, in some form of legally enforceable undertaking. This undertaking may be delivered to a third party to be held in escrow up to a fixed deadline. By disclosing its valuation and committing to such an undertaking (thus putting itself in a position where proposing a fair valuation constitutes its optimal strategy), a party that wishes to end its joint-ownership relationship with another party can act in a manner that is demonstrably fair and can easily demonstrate to an Audience that it has acted in such a fair manner. And this is so even where the Audience lacks any knowledge of, and has no interest in learning about, the value of the property in question. See generally, with regard to buy-sell arrangements, U.S. patent application Ser. No. 12/229,796, filed Aug. 26, 2008 by the present inventor and Steven J. Brams, at pp. 3-7, the entire Disclosure of which is also incorporated herein by reference.

E.6 The Utility of Computerized Systems in Connection with Commitments Relating to Bargaining

As was noted in the preceding subsection, a joint-property owner that wishes to initiate a traditional buy-sell arrangement does so, in part, by disclosing its proposed valuation to its adversary and then ceding to its adversary the right to elect to take certain actions up to a fixed deadline. Thus, in traditional buy-sell arrangements (as distinct from the non-traditional buy-sell arrangement described in the patent application cited at the end of the preceding subsection) there is no particular need for any of the involved parties to be concerned about issues such as confidentiality and signaling of weakness. However, such issues are of paramount importance in most if not all disputes in which one party is seeking money or other concessions from another party, so much so that—even where there is no genuine basis for concern about confidentiality or a signaling of weakness—if one party can identify any rational basis for professing concerns about how such issues will be addressed in a given bargaining process, that party can justify declining to proceed with that process and may well be excused by an Audience for having done so.

For example, and as was noted supra at pp. 14-18, first parties and second parties may both rationally decline to propose or agree to a proposal to use a mediation service or a symmetrical sealed-bid system out of a fear of signaling weakness. In addition, and as was noted supra at p. 19, first parties and second parties may both rationally decline to disclose the value at which they would actually be willing to settle a case unless and until they can be certain that the other side will accept that value (out of a fear that the other party will use that value as a starting point for demanding further concessions).

Nor can these concerns be fully addressed by simply introducing a third-party human actor into the process, such as an actor who could examine each party's proposed settlement value in confidence and agree not to reveal those values unless they met or overlapped (in which event he or she could announce a settlement). This is because no human actor is capable of erasing his or her own memory, and the possibility that the actor in question might subsequently reveal or be forced to reveal a party's proposed value—perhaps in response to formal legal process issued at the behest of one's adversary, notwithstanding the many objections to such testimony that could be raised on public policy grounds—may provide a party (such as a second party who was invited to participate in such a process) with an excuse for refusing to proceed. Moreover, on a more immediate and fundamental level, a party (such as a second party) could rationally insist upon having to interact with the human actor prior to consenting to the process, both for purposes of gaining confidence in the human actor's character and for getting information and assurances from him or her as to how the process would be conducted. Yet the mere act of engaging in such an exploratory interaction could arguably be cited as involving a signaling of weakness and thus cited as a basis for declining to proceed with the process. No human actor can credibly suggest that he or she would be able to erase his or her own memory of such an interaction with a party, or of a settlement proposal subsequently submitted by that party.

These issues would not be of particular concern in cases where the first party and the second party were both willing to engage in conduct that involved signaling weakness, such as by entering into a mutual agreement to use the process prior to doing so. But in cases where a first party is dealing with a recalcitrant second party (i.e., a second party that will seek to come up with excuses to an Audience as to why the second party declined to go forward with a bargaining process initiated by the first party) the first party's ability to deprive the second party of such excuses will be enhanced if the first party utilizes a bargaining process that is carried out from beginning to end by a computing machine.

The concept of using a computerized mechanism as “mediator” and as a device to enhance the ability of parties to engage in efficient bargaining was explicitly referenced by Schelling as long ago as 1960, long before the advent of the current computer age:
The role of mediator is another element for analysis in game theory . . . . Mediators can . . . be a means by which rational players can put aside their rational faculties. A mediator can consummate certain communications while blocking off certain facilities for memory. (In this regard he serves a function that can be reproduced by a computing machine.) He can, for example, compare two parties' offers to each other, declaring whether or not the two offers are compatible without revealing the actual offers. He is a scanning device that can suppress part of the information put into it. He makes possible certain limited comparisons that are beyond the mental powers of the participants, since no player can persuasively commit himself to forget something.”
Schelling, Thomas C. (1960), pp. 143-145 (cited supra at p. 6).
   E.7 Examples of Currently Operating Computerized Systems that can be Used by First Parties to Unilaterally Commit to Certain Bargaining Processes, Thereby Influencing Certain Audiences

By way of concluding this summary of the background of the current invention, it should be noted that are currently two computerized online bargaining mechanisms—one of which was invented and one of which was co-invented by the present inventor—that are presently fully operational and that, as with the present invention, (a) can be used by first parties to unilaterally commit to certain bargaining protocols, and (b) can be used to make demonstrations to certain Audiences that a party has acted fairly within the context of certain types of claims. However, as discussed below, these two systems do not serve to fully address the problem for which the present invention provides a complete solution.

The first of the two computerized online bargaining mechanisms referenced above is an online computerized version of the invention disclosed in U.S. patent application Ser. No. 12/229,796, filed Aug. 26, 2008 by the present inventor and Steven J. Brams. This system (the “Fair Buy-Sell System”) is presently available for public use and can be accessed via the following URL address: https://www.fairoutcomes.com/run_fbs/home.pl. The Fair Buy-Sell system can be used by joint owners of property—such as business partners, joint venturers, shareholders, and married couples—to bring their joint ownership to an end in a fair, efficient, and legally enforceable manner. The system provides each party with an opportunity to enter data into the system under an escrow arrangement, including confidential data specifying a monetary value for the property at which that party would be willing either to sell its share to the other side or buy out the other side's share (similar to the proposal made by the initiating party under a traditional “buy-sell” arrangement, as discussed supra at pp. 22). The system compares the offers and announces a sale to the party that offered the higher value. However, the sale price is set at the midpoint between the offers (or at some other intermediate value arrived at by applying a mutually agreed-upon formula).

The use of the Fair Buy-Sell System by the involved parties always produces a full and complete resolution, and it always provides each party—whether the buyer or seller—with a resolution that is equal to or more favorable to it than the one that it had proposed. The system can be used pursuant to a prior agreement between the parties, but it is configured so that it can also be initiated unilaterally by one party, allowing that party to either achieve an outcome that equals or exceeds what that party considers to be acceptable or—if the other party declines to use the system—to demonstrate to an Audience, without having to reveal its own proposed valuation to the Audience or the other party, that the other party had walked away from a fair and reasonable solution.

The second of the two computerized online bargaining mechanisms referenced above is an online computerized version of the invention disclosed in U.S. patent application Ser. No. 11/066,047, filed Feb. 24, 2005 by the present inventor. This system (the “Fair Proposals System”) is presently available for public use and can be accessed via the following URL address: http://www.fairoutcomes.com/fp.html. In cases in which one party is seeking money or other concessions from another party, such as in a lawsuit, and in a wide variety of other bargaining contexts (such as negotiations over a purchase or sale of real estate), the Fair Proposals System allows each party to propose a resolution that it deems fair in a manner that is credible but non-prejudicial. A party's proposed resolution remains confidential and does not become enforceable unless the system determines that it is acceptable to the other side, at which point it becomes the resolution.

The Fair Proposals system can be used by mutual agreement or, by virtue of its asymmetrical structure, can be initiated and used unilaterally by one party without the other party's consent or cooperation. Unlike mediation and traditional sealed-bid systems, the system gives the initiating party a strong incentive to make a reasonable proposal at the outset of the process, and it deprives the other party of an incentive or excuse for failing to do the same prior to a fixed deadline. A party that proposes a reasonable outcome will either obtain that outcome or will, without having caused prejudice to its own bargaining position, be able to demonstrate to an Audience that the other side had walked away from a reasonable settlement that had been within its grasp.

It will be appreciated that the Fair Buy-Sell system only applies to situations involving jointly-owned property (or similar-but-separately-owned property), and thus would not have any application in the vast majority of e-commerce disputes or in situations in which one party was simply seeking money or other concessions from another (in such situations, the plaintiff or claimant is always—in effect—“selling” a release of its claim to the defendant or respondent, with the result that, in contrast to the bargaining dynamic addressed in the Fair Buy-Sell System, the identity of the buyer and seller are always known in advance, and uncertainty over who will buy and who will sell cannot be used as a device to impose constraints upon the parties' optimal strategies). Yet the Fair Buy-Sell System should be taken into account in considering the background of the present invention because, as was noted with respect to traditional buy-sell systems supra at p. 22, it allows a party to demonstrate to an Audience that it has acted in a fair manner with respect to its bargaining adversary even where the Audience lacks any knowledge of, and has no interest in learning about, the value of the property in question. Thus, as is the case with the present invention, the Fair Buy-Sell System allows a party to make such a demonstration to an Audience that is intent upon remaining willfully ignorant about the underlying merits.

Unlike the present invention and the Fair Buy-Sell System, the Fair Proposals System would have less utility in a situation where one was dealing with and attempting to make a demonstration that one had acted fairly in a given dispute to an Audience that was intent upon remaining willfully ignorant about the underlying merits. The Fair Proposals System allows a party that has knowledge of the underlying merits (such as the parties themselves and any Audience that is interested in the dispute) to make a credible determination as to whether a party's adversary was willing to accept a given outcome and—in cases where that system does not produce a settlement—to reasonably infer and credibly demonstrate to an Audience that its adversary had walked away from that given outcome. However, an Audience that was intent upon remaining willfully ignorant as to whether that given outcome was a reasonable outcome would thereby effectively preclude itself from determining whether the first party had acted in a fair and reasonable manner.

Notwithstanding the fact that the Fair Proposals system is primarily designed for use by an informed party or Audience, that system should also be taken into account in considering the background of the present invention because the present invention can be used in combination with a version of the Fair Proposals System so as to provide a perfect solution to the problem discussed in this Disclosure. For example, and as is discussed in subsequent sections of this Disclosure, a computerized online bargaining system that comprises such a combination is presently available for use online, providing a complete solution to the problem described herein in cases where the first party is an e-commerce seller and the Audience wishes to remain willfully ignorant of the merits of the underlying dispute.

### OBJECTS OF THE INVENTION

The objects of the invention that is the subject of this Disclosure may be briefly summarized as follows:
i) To allow a first party that is involved in a dispute with a second party to either achieve a resolution of that dispute on terms that the first party deems to be acceptable or to be able to credibly demonstrate to an Audience that the first party has acted fairly in connection with that dispute.
ii) To allow a first party to accomplish the objective set forth in paragraph (i) above unilaterally, without having to secure the consent or cooperation of the second party, and without having to incur prejudice to its bargaining position with respect to the second party.
iii) To allow a first party to make a credible demonstration as described in paragraph (i) above to an Audience that is disinterested in, indifferent to, or incapable of becoming informed about the merits of the underlying dispute.
iv) To assist a first party that is involved in a dispute with a second party and that is willing to settle the dispute on certain definite terms, but who is unwilling to disclose all of those terms to the second party unless and until there is a determination made that those terms are acceptable to the second party, to be able to make a determination as to whether those terms are acceptable to the second party without first having to arrive at any interim agreement with, or having to signify any willingness to compromise or negotiate with, the second party.
iii) To provide a first party that is involved in a dispute with a second party with a means for providing the second party with an incentive to contemplate, reflect, and come to a reasoned decision with respect to what might constitute a fair settlement, and to commit itself to accepting such a settlement.
v) To provide parties that have reached an apparent deadlock in settlement negotiations with a mechanism for either breaking the deadlock or confirming that a deadlock has in fact been reached.
vi) To provide a party that is involved in a dispute with an adversary and that lacks confidence in its own ability to negotiate, or that lacks confidence in the capacity of its adversary to negotiate in good faith, with a means for seeking and securing a fair settlement from its adversary.
vii) To provide an Audience with a means by which it can call upon a first party that is involved in a dispute with a second party to demonstrate that the first party has acted in a fair manner with respect to that dispute.

(Further objects and advantages will become apparent from a further consideration of this Disclosure and the ensuing description).

### BRIEF SUMMARY OF THE INVENTION

The invention that is the subject of this Disclosure consists of a method whereby a first party that is involved in a dispute with a second party may enter data into a computerized system that will either produce a resolution of that dispute on terms that are acceptable to the first party or allow the first party to easily and credibly demonstrate to an Audience that it has acted fairly in connection with that dispute.

The data entered into the computerized system by the first party consists of data (a) identifying the parties, their addresses, and the nature of the dispute; (b) specifying a set of terms under which the first party would be willing to settle a dispute with a second party if those terms were accepted by the second party prior to a specified deadline; and (c) signifying the first party's agreement—if those terms are not accepted by the second party prior to said deadline—to (i) submit those terms to final-offer arbitration for a determination as to whether those terms were fairer than an alternative set of terms that may be specified by the second party prior to the deadline, and (ii) to allow the second party to elect, prior to that arbitration, to have that determination be binding or non-binding upon the parties in the event that said second party loses the arbitration.

Following the submission of the above-described data, that data is held as escrow within the computerized system and the system thereupon sends an invitation to the second party at the address specified by the first party to enter data into the system. Specifically, the second party is invited to enter data, up to the deadline specified by the first party, signifying the second party's agreement to accept the terms proposed by the first party provided that those terms are equal to or more favorable to the second party than certain terms that the second party specifies within that data.

In the event that the second party submits such data, the computerized system makes a determination as to whether or not the terms proposed by the first party are equal to or more favorable to the second party than the terms specified by the second party (in the event that they are, then the second party would be deemed of a have accepted the first party's terms, and the underlying dispute would be resolved).

If the system determines that the terms specified by the first party are not equal to or more favorable to the second party than the terms specified by the second party, then the system would disclose that determination to the second party and provide the second party with an opportunity to submit data signifying the second party's agreement to have the terms specified by the respective parties submitted to final-offer arbitration for a determination as to which terms were fairer (as already agreed to by the first party at the time that the first party submitted its initial data). In addition, and consistent with the option granted by the first party at the time that the first party entered its initial data, the system would also provide the second party with an opportunity to enter data signifying the second party's election to either have the terms determined to be fairer within the final-offer arbitration be (a) binding upon both parties, or (b) only binding upon the parties in the event that the second party wins the arbitration (i.e., only binding if the final-offer arbitration results in a determination that the second party's proposed terms were fairer).

Upon the submission of such additional data by the second party, the system will generate and send to each party a certificate attesting to the manner in which that party used the system and the results of that use. If the second party fails to submit such additional by the deadline (and assuming that the matter was not previously resolved as described in paragraph above, in which event both parties would have already received confirmation of the settlement of the dispute), the system will generate and send the first party a certificate attesting to the manner in which the first party used the system and the results of that use.

The system will treat as confidential any information relating to either party's use of the system except to the extent that that party has authorized the system to disclose specific information about one or more aspects of that party's use of the system.

### BRIEF DESCRIPTION OF THE SEVERAL VIEWS OF THE DRAWING(S)

The following drawings have been submitted together herewith:

Drawing 1: A Step Diagram of the Method Described in claim 1 (one page).

### DETAILED DESCRIPTION OF THE INVENTION

### H.1 Preliminary Comments Concerning the Manner in Which the System is Configured

It should be noted as a preliminary matter that a version of the preferred embodiment of the invention that is the subject of this Disclosure—a version that can be used by an e-commerce seller in cases where it is involved in a dispute with a buyer in which the buyer is claiming an entitlement to money—is currently available for public inspection and use via the following URL address: https://www.fairoutcomes.com/run_fr/home.pl. Configuring the computerized system (the “system”) through which data is entered and processed in a manner such that the system can be easily accessed and utilized via the world-wide web, as was done at the above-referenced website, enhances the ability of a first party to use the system for its intended purpose. For example, a first party's ability use the system to either achieve a settlement or demonstrate that it has treated the second party in a fair manner will be enhanced in direct proportion to the extent to which the system has been configured in a manner so as to increase the Second Party's ability to utilize it with ease and with confidence. From the perspective of all parties, the preferred configuration of the system consists of a configuration that maximizes the ability of the second party to use it with ease and confidence.

### H.2 Preliminary Comments Concerning the System Administrator

As was noted within the Brief Summary of the Invention at paragraph [0049], supra at p. 32, the data entered into the system by the first party is held as escrow by the system. In order for the system to hold escrow, the system must be administered and maintained by a person or entity (the “system administrator”) that is legally distinct from the parties utilizing the system. As with traditional escrow agents, such as bankers and lawyers who provide escrow services in the ordinary course of their business, the system administrator is preferably neutral, and its obligations to the parties are limited to obligations that it elects to undertake, either through simple contracts with, or through representations made by and between, those parties.

In order for the system administrator to be effective and enjoy the trust of parties utilizing the system, the system administrator preferably needs to be able to satisfy the expectations that parties generally have when they utilize a lawyer or banker as an escrow agent in more traditional escrow transactions. These expectations include an ability to recognize and disclose any potential conflicts of interest, to hold information in strict confidence, to hold documents and data in secure locations, to make accurate determinations as to whether the conditions for a release of the escrow have been met, and to engage in secure transactions. For this reason, the system will in many instances perform best if it is administered by an entity such as a law firm or bank that already provides escrow services.

H.3 Description of the Manner in Which the First Party May Interact with the System when the System is Accessible Via an Online Website

As was noted within the Brief Summary of the Invention at paragraph [0048], supra at p. 31, the first party (hereinafter assumed to female) initiates the use of the system by entering data into the system. Where access to the system has been made available to her via a publicly accessible website (such as at https://www.fairoutcomes.corn/run_fr/home.pl), she can do this by simply visiting the website and performing a series of simple data entry operations. These data entry operations are similar to the sorts of operations that a party engages in when using a website to purchase an airline ticket or purchase some other item that can be routinely purchased online on standard commercial websites.

Where the first party is accessing the system via a website then, as with a standard commercial website, a home page on that site provides her with basic information concerning how the system works and access to other pages that she can use to learn more about the system and the system administrators. For example, the website's pages may include a page upon which the system administrator's privacy policies are set forth in a series of legally enforceable representations that are made to visitors to the site. These pages may also include a page setting forth a series of representations made by the system administrator concerning the respective rights and obligations of the system administrators and users of the system. Additional representations about specific policies, rights and obligations may be made on various other pages that appear as a first party engages in the process of entering data into the system, as in most commercial websites through which a party can purchase goods or services.

As with most commercial websites, the first party may, before proceeding to use the system, be invited to “register” with the website by providing identifying information such as her name, e-mail address, and mailing address. This allows her to be given a user name, password and account number and allows for the generation of a series of private web pages associated with that account number that cannot be accessed by anyone except by use of her user name and password. These private pages can then be used by her to enter the requisite data into the system.

### H.4 Example of the Manner in Which the System May Receive Data Form the First Party Via an Online Website and in Which Such Data May be Processed

For purposes of providing a detailed description of the invention, the discussion which follows provides an example of the process that the first party would go through when using a version of the system that was accessible online and that was configured for use in situations where the first party's dispute with the second party (hereinafter assumed to be male) consisted of a dispute in which one of those two parties was seeking a payment of money from the other. (Configurations that can be used where one of the parties is seeking something other than an amount of money—such as an agreement upon a percentage of money, or a term of years, or rights within a specific geographical region—would in almost all other respects be identical to the configuration described below and are briefly discussed infra at p. 53.)

After registering to use the system and proceeding to a private page of the website, the first party would enter data into the system by which:
(1) She identifies the names, addresses, and e-mail address of the involved parties, indicating which of the two parties is seeking money from the other;
(2) She describes the general nature of the matter that gave rise to the claim (e.g., “the matters referenced in my/your letter of Dec. 31, 2008,” or “the contract between Smith and Doe dated Dec. 31, 2008,” or “the matters referred to in the complaint filed in Smith v. Doe, Civil Action No. 357”);
(3) She confidentially specifies an amount of money for or at which she would be willing to settle the claim (which may be zero or any greater amount, said amount being hereinafter referred to as “x”), with the express understanding that said amount will not be disclosed unless the system determines that it is acceptable to the other party; and
(4) She specifies a date at which her willingness to settle the matter on the terms described above will come to an end (hereinafter referred to as the “deadline”).

Once she had entered data identifying the parties and signifying which party was claiming an entitlement of money from the other, she would be able to access another private page of the website where she could see a draft “Term Sheet” setting forth various representations and undertakings that she would be making to the second party in the event that she elected to authorize the system to issue an invitation to the second party to use the system. (Note that, for her ease and comfort in using the system, she could initially enter hypothetical data for purposes of accessing the draft Term Sheet—she would not need to enter accurate data unless and until she wished to authorize the system to send a copy of the Term Sheet to the second party). As she enters the data described in the preceding paragraph, that data would be automatically transposed onto the draft Term Sheet Oust as personalized data entered on standard commercial websites is transposed onto subsequent pages as a visitor progresses through a process of, for example, making an online purchase).

For example, the data that she entered into the system would, under this example, be automatically transposed by the system in the following manner: (i) the names and addresses of the parties that she entered would appear at the top of the draft Term Sheet (ii) the data that she entered describing the dispute would (once she had entered that data) appear in a reference line beneath those signatures; and (iii) the data that she entered defining the deadline would (once she has entered it) appear within the text of the draft Term Sheet. However, the data she entered with respect to the amount of money for or at which she would be willing to settle the dispute would be stored by the system (in the same manner in which a standard commercial website stores confidential password information) but would not be disclosed within the Term Sheet. Instead, that monetary term would be referenced within the draft Term Sheet, and in any actual Term Sheet that is subsequently issued, by the letter “x.” An example is set forth in the subsection that follows:

H.5 Example of the Manner in Which Data Entered by the First Party into the System Via an Online Website May be Used to Generate a Set of Undertakings by the First Party

By way of providing a specific example, the text of a draft Term Sheet has been set forth bellow. This text was generated by “Jane Doe” on the version of the system that is presently being administered by Fair Outcomes, Inc. and that is presently accessible online at https://www.fairoutcomes.com/run_fr/home.pl. Jane Doe generated the text of this draft Term Sheet by entering data in which she (i) identified the parties (Jane Doe and “John Smith”) and signified the fact that John Smith was seeking money from Jane Doe (ii) described the subject matter of the dispute as “Smith v. Doe, Claim No. 357,” and (iii) specified a deadline of “Feb. 24, 2009” (note that data transposed from Jane Doe's data entries appears in italics below):

Re: Smith v. Doe, Claim No. 357.
Jane Smith hereby invites John Doe (“you”) to use the process described below to resolve and settle any claims or disputes relating to the above-referenced transaction. Jane Smith specifically agrees and represents as follows:
(1) Jane Smith will cause a specified amount of money (“X”) to be paid to you within seven days if, prior to a fixed deadline (Feb. 27, 2009 at 12:00 Hours (i.e. 12 Noon) U.S. E.S.T.) and in the manner described below, you agree to accept that amount to fully resolve and settle any claims or disputes relating to the above-referenced transaction (i.e., to “Settle for X”).
(2) Jane Smith has disclosed the amount of X to Fair Outcomes, Inc. of Boston, Mass. and has caused that company to deliver a username and password to you for your use on the Fair Reputations system (the “System”) that appears on that company's website (https://www.fairoutcomes.com/run_fr/home.pl). That username and password will allow you, up to the above-stated deadline, to confidentially use the System to enter data signifying your willingness to Settle for X provided that:
(a) X is greater than or equal to an amount of money that you specify within that data (“Y”); and
(b) X is paid to you within seven (7) calendar days of the date upon which you submitted that data.
(3) Fair Outcomes, Inc. will not disclose any data that you enter, or any use or non-use that you may make of the System or of its website, to Jane Smith or to anyone else except to the extent provided for under paragraphs 5 and 7 below.
(4) If you enter data as described at paragraph 2 above, then the System will at that time automatically determine and advise you of whether or not X is greater than or equal to Y.
(5) If the System determines that X is greater than or equal to Y, then Fair Outcomes, Inc. will at that time issue a formal certificate to you and to Jane Smith disclosing the amount of X and attesting to the fact (a) that you had agreed to Settle for X provided that that amount was paid to you within seven (7) calendar days, and (b) that Jane Smith had agreed to cause that amount to be paid to you within that seven day period.
(6) If, alternatively, the System determines that X is not greater than or equal to Y, then the System will at that time, and on each occasion that you submit such data prior to the deadline, notify you of that fact and provide you with an opportunity:
(a) to submit data specifying a different value for Y; or
(b) to log out of the System (in which case you would be allowed to log in and use the System again at anytime prior to the deadline); or
(c) to have Fair Outcomes, Inc. disclose the amount of X and the final value that you specified for Y to an impartial arbitrator for a determination as to which amount (i.e., X or Y) was fairer given the underlying circumstances.
(7) If you select arbitration pursuant to paragraph 6(c) above, then you will also, at that same time, be given an opportunity to elect:
(a) to have the arbitrator's determination be binding upon both parties (in which event the amount selected by the arbitrator as being fairer will be disclosed to both parties as the settlement amount and Jane Smith will cause that amount to be paid to you within seven days of the arbitrator's ruling); or
(b) to only have the arbitrator's determination be binding in the event that the arbitrator rules in your favor (in which event there will be no settlement, payment or disclosure of the amount specified by either party unless the arbitrator rules in your favor—in the event that the arbitrator rules in your favor, then the amount that you specified (Y) will be disclosed to both parties as the settlement amount and Jane Smith will cause that amount to be paid to you within seven days of that ruling).
   Your selection of arbitration would be disclosed to Jane Smith and to the arbitrator, but your election as to whether to have the arbitration be binding upon both parties, or to only be binding if the arbitrator rules in your favor, will not be disclosed by Fair Outcomes, Inc. to Jane Smith or to the arbitrator until after the ruling is made.
(8) Additional information about the above-described process and about Fair Outcomes, Inc. is available on the above-referenced website.
   H.6 Comment on Alternative Undertakings that May be Processed and Generated by the System

It will be appreciated that the system could be configured in alternative ways to that set forth in the example discussed above. For example, the system may be configured so as to allow the first party, at the time that she enters data for the purposes of transposition onto a Term Sheet, to also enter data identifying one or more arbitration service providers (e.g., the American Arbitration Association, the International Chamber of Commerce, etc.), which data could then be transposed into a draft Term Sheet containing text that would differ from that set forth in the above sample (for example, the system could be configured so that she could enter the names of several arbitration service providers, and the text of the Term Sheet would then signify an undertaking by her to allow the second party to select a provider from that list. Similarly, the system may be configured so as to allow her to enter data such that the Term Sheet would set forth various undertakings with respect to the issue of the arbitrator's fees, such as an undertaking to pay those fees herself, or to share those fees equally with the second party, or to have the loser of the arbitration pay the fees, or to abide by any determination made by the arbitrator on who should pay those fees. Numerous other configurations are possible.

By way of further example, it would also be possible to configure the system so as to vary some of the other undertakings made and representations set forth in the sample Term Sheet set forth above, such as the provision in paragraph 6(a) of that that sample to the effect that, if “the System determines that X is not greater than or equal to Y, then the System will at that time, and on each occasion that you [the second party] submit such data prior to the deadline, notify you of that fact and provide you with an opportunity . . . (a) to submit data specifying a different value for Y.” In this regard it should be noted that providing the second party with an opportunity to submit alternative values under such circumstances (e.g., “on each occasion”) does not constitute an element of the present invention (although it does constitute an element of the invention that underlies the Fair Proposals system discussed supra at page pp. 27-29), and thus it would in theory be possible to not incorporate such an element into an embodiment of the present invention.

However, incorporating such an element would under most circumstances enhance the utility of any given embodiment of the present invention, because it would serve to deprive a second party that failed to achieve a resolution of the dispute through a use of the system from attempting to argue to an Audience that he had made a proposal that he thought would be accepted but that he simply “guessed wrong” and was then foreclosed from putting forth a more conciliatory proposal because the process came to an end. In this regard it should also be noted that it would be possible to utilize variations of this particular element, such as by allowing the second party to make a revised proposal if, and only if, it was more favorable to the first party than the previous failed proposal (thus preventing a second party from retreating to a more aggressive position prior to electing final-offer arbitration).

### H.7 Comment on Final-Offer Arbitration Procedures, Generally

Note that the performance or carrying out of a final-offer arbitration process (as distinct from processing data offering or comprising an agreement to use such a process) does not constitute a step or element of the invention that it is the subject of this Disclosure. However, the manner in which such an arbitration process works, in general, is worthy of note within this context. For the purposes of this Disclosure, it should simply be noted that, in the event that parties proceed to final-offer arbitration, then the arbitrator will make a determination as to which party's proposal—e.g., x or y—was fairer given the underlying circumstances. Under this procedure, the arbitrator must choose one or the other of the two proposals—he or she cannot propose a compromise. Brams, S. J., Kilgour, D. M. and Merrill, S. (1991) “Arbitration Procedures.” In H. Peyton Young (ed.), Negotiation Analysis. (Ann Arbor, Mich.: University of Michigan Press), pp. 47-65. The determination as to which proposal was fairer is generally based on the arbitrator's assessment of what the legal community in the relevant jurisdiction would view as a fair settlement in light of the circumstances of the case, the applicable law, and the attendant risks to both parties if the matter was not settled. The arbitrator will typically determine that a reasonable settlement would fall somewhere within a range, say, between a and b. The party whose offer is closest to the midpoint of that range will be deemed to have submitted the fairer offer and will win the arbitration.

### H.8 Comment on the First Party's Formulation of Her Proposed Settlement Terms

Note that, within the version of the preferred embodiment of the system described in subsection H.4 above, the first party's formulation of her proposal (i.e, her formulation of “x” as referred to in the sample Term Sheet set forth above) takes place in the shadow of final-offer arbitration. This is an element of, and an inherent aspect of, all embodiments of the present invention. Thus, in the above-described example, the first party must, in formulating x, take into account the possibility that, if the matter is not resolved prior to the deadline and the second party elects arbitration, then the arbitrator may enter an award of the second party's proposal (“y”) if the arbitrator concludes that y is fairer than x.

This imposes a level of discipline on the first party in formulating x. Specifically, self-interest requires her to calculate x by reference to what she believes an arbitrator would deem to be fair, rather than by reference to what she subjectively considers to be fair. (Importantly, this aspect of the system is known to both parties, and it applies as well to a final proposal made by the second party prior to the deadline.) Self-interest requires that the First Party formulate x such that it falls within the range of what she believes an arbitrator would consider to be fair. (Note that an arbitrator's determination of what was “fair” would not be made by reference to some abstract, platonic ideal of justice, but rather by reference to what the legal community in the relevant jurisdiction would view as a fair settlement in light of the circumstances of the case, the applicable law, and the attendant risks to both parties if the matter was not settled.)

### H.9 Comment on the Confidentiality of the First Party's Proposal

As may seen from the example discussed above, the settlement terms specified by the first party will not be fully disclosed to the second party unless the matter either (i) settles prior to the deadline (in which event the matter settles on the basis of the first party's terms, e.g., x) or (ii) proceeds to an arbitration that is binding upon both parties and at which the first party's proposal is determined to be fairer than then the second party's proposal. Confidentiality with respect to at least one term within the first party's proposal (typically the penultimate term, such as a dollar amount, percentage figure, term of years, etc.) is an inherent aspect of all embodiments of the invention—the computerized system will not reveal such information unless explicitly authorized to do so by the first party (although the first party is always free to make such an authorization, or to make such a disclosure directly to the second party). This feature allows the first party to commit herself to a fair proposal without having to fear that, if the matter is not resolved, her proposal will simply become a starting point for demands for further concessions. See, e.g., Schelling (1960), pp. 34-35 (cited supra at p. 6). Treating one or more of the terms specified within the first party's proposal as confidential thus enhances the first party's ability to put forth a fair proposal. See, e.g., Gertner, R. H. and Miller, G. P. (1995). “Settlement Escrows.” Journal of Legal Studies, Vol. 24, Issue 1, pp. 87-122 (available on-line at: http:/www.law.uchicago.edu/Lawecon/WkngPprs_{—}01-25/25.Miller.Escrows.pdf), at p. 6 (page numbers cited in this Disclosure correspond to the pages in the PDF version). By depriving her of an excuse for failing to put forth a fair proposal, confidentiality also serves to enhance the credibility of her proposal. This feature is, accordingly, beneficial to both parties and cannot be credibly cited by the second party as a justification for refusing to use the system, or by an Audience as undermining the fairness of the process as a whole.

### H.10 Comment on the First Party's Allowing the Second Party to Act in Confidence

As may also be seen from the above-example, no information about any use or non-use of the system by the second party, and no information about any settlement terms proposed by the second party, will (absent explicit authorization from the second party) be disclosed by the system to the first party unless the matter either (a) settles through the use of the system prior to the deadline (in which event the matter would settle on the basis of the first party's proposal, e.g., settle for x, and the first party would know that the second party had used the system and could fairly infer that the second party had made a proposal that was equal to or less favorable to the second party than the first party's proposal) or (b) proceeds to an arbitration (in which event the first party would know that the second party had used the system and would receive full information about the second party's proposal if, and only if, the second party won the arbitration). Such confidentiality with respect to any interactions that the second party may or may not have with the system is an inherent aspect of all embodiments of the invention—the computerized system will not reveal such information unless explicitly authorized to do so by the second party (although the second party is always free to make such an authorization, or to make such a disclosure directly to the first party).

By forswearing any right to know about any use that the second party may make of the system unless that use produces a settlement or a referral to final-offer arbitration, the first party deprives the second party of an excuse that the second party might otherwise try to cite to an Audience for failing to respond to the first party's initiation of the system: that the second party's use of the system might signal weakness, i.e., of a willingness to consider compromise or to reconsider his publicly stated position. For example, and as was noted above, if a party agrees to use mediation or a traditional sealed-bid system, then “his adversary may infer that [his] case is weak. Therefore, [he will not agree to use such a system] despite the fact that [he] would be better off if [a sealed-bid system was somehow] forced upon [him].” Gertner and Miller (1995), p. 38 (cited supra at p. 45). This feature deprives the second party of such an excuse and, in combination with the system's other features, effectively allows the system to be “forced upon” him, to the benefit of both parties.

H.11 Comment on First Party's Undertaking to Settle the Matter on the Basis of the First Party's Proposal (x) in Cases where x is More Favorable to the Second Party than the Second Party's Proposal (y).

It will be observed that, within the version of the preferred embodiment of the system described within the example set forth above, if the term proposed by the first party (x) is equal to or more favorable to the second party than the term proposed by the second party (y), then the first party's proposed resolution, x, becomes the resolution and the claim will have been settled through the use of the system. This is an inherent aspect of all embodiments of the invention, and stands in marked contrast to the arrangement employed in so-called “split-the-difference” versions of symmetrical sealed-bid systems, under which “[i]f the [system administrator] receives offers which cross—if the defendant offers more to settle than the plaintiff demands—the [administrator] imposes a settlement at the midpoint of the offers.” Gertner and Miller (1995), p. 1 (cited supra at p. 45). This contrast is attributable to the fact that the incorporation of a “split-the-difference” feature into a bargaining mechanism serves to provide a second party with an additional excuse that it could cite to an Audience in seeking to justify its refusal to use that bargaining mechanism—namely, a fear of losing surplus or, in the vernacular of real-world bargaining, of “leaving money on the table.” This would occur if a second party utilizing such a system inadvertently proposed an outcome that was less favorable to him than what the first party was ready and willing to grant.

Recall that the first party, in initiating the use of the system, has already arrived at a position where she is not transfixed by the prospect of losing some hypothetical surplus (similar to the position that virtually all parties find themselves in when they arrive at the eve of trial, because no bargainer can ever truly know whether they are leaving money on the table). Having already arrived at that position, her primary goal in using the system is to try to bring the underlying conflict or problem to an end on terms that she has defined as acceptable (i.e., either her proposal or, failing that, what an impartial arbitrator considers to be more fair), while at the same time ensuring that, if her adversary declines to use the system, her adversary will be the only party that will suffer prejudice as a result.

### H.12 Comment on the First Party's Granting of an Option to the Second Party Under Which the Second Party can Opt Not to be Bound by the Arbitration Unless He Wins

It will be noted that, within the version of the preferred embodiment of the system illustrated by the example set forth above, the first party grants the second a party an option to elect to have the outcome of the final-offer arbitration be non-binding in the event that the arbitrator makes a determination that the settlement terms proposed by the first party were fairer than the settlement terms proposed by the second party. This is an inherent feature of all embodiments of the invention. It may be asked why a first party would want to grant a second party the option of electing an asymmetrical arrangement under which she would be bound by the outcome if she lost in arbitration, whereas he could elect in advance not to be bound if she won. The answer is that, by so doing, she deprives him of the ability to refuse to proceed to final-offer arbitration on the basis of a professed fear that he might not get a fair hearing and thus might lose.

This feature makes the system particularly well-suited for use in disputes in which a lawsuit is not a practical option for either party, but where the first party is confident that she has treated the second party fairly (i.e., that she would win in any arbitration) and is primarily interested in demonstrating that fact to a relevant Audience, including an Audience that was disinterested in, indifferent to, or incapable of becoming informed about the merits of the underlying dispute. An agreement by her to allow him to opt not to be bound by the arbitration in the event that he loses precludes him from even taking issue with an Audience's conclusion that the first party has treated him in a transparently fair manner.

For example, within the context of an e-commerce dispute, a first party is not primarily interested in having both parties bound by the outcome of the arbitration if she wins but, rather, in obtaining relief from the harm that the second party has, justifiably or unjustifiably, inflicted upon her reputation rating. So long as the administrator of the involved e-commerce site (or reputation-rating system) considers the arbitration process that was offered to the second party to be fair (i.e., to have provided him with adequate due process in light of the size and nature of the underlying dispute), an arbitrator's finding in favor of the first party should cause that administrator to provide relief with respect to the reputation issue, notwithstanding the fact that the second party did not elect to be bound. In such cases, the second party is effectively left in a position where he is free to pursue his claim in a court of law. But he can no longer justifiably expect the administrator of the e-commerce site (or reputation-rating system) to take his negative feedback into account in calculating the first party's reputation rating, nor can he expect any Audience to infer that he was not treated fairly, because at that point he will have elected to walk away from a settlement that an impartial arbitrator found to be fair or, at the very least, fairer than the final proposal made by the second party. (Note also that, in cases where the second party wins the arbitration, the first party's reputation should also be restored, because under those circumstances she would have put the second party in a position where he could obtain, and did obtain, what he considered to be a fair outcome in a highly efficient and fair manner).

H.13 Manner in Which the System Provides the Second Party to with an Opportunity to Submit Data Into the System

As was noted within the Brief Summary of the Invention at paragraph [0049], supra at p. 32, following the submission of the above-described initial data by the first party, that data is held as escrow within the computerized system and the computerized system thereupon sends an invitation to the second party at the address specified by the first party within that data (in the preferred embodiment, via e-mail), inviting him to enter data into the system. Specifically, the second party is invited to enter data, up to the deadline specified by the first party, signifying the second party's agreement to accept the terms proposed by the first party provided that those terms are equal to or more favorable to the second party than certain terms that the second party specifies within that data.

As may be seen from the example described supra at pp. 39-41, the System may perform this function by simply causing a copy of the Term Sheet to be sent to the second party at the address entered into the system by the first party. At the time that the System sends the Term Sheet to the second party, the System generates and includes within its transmission to the second party a confidential password that the second party can then use to access confidential pages on the website that are associated with the account that was registered on that website by the first party. (Note that, in e-commerce transactions, the e-commerce site administrator has a record of the address used by the second party in connection with the underlying transaction, and this is the address that prudent first parties would enter into the system, as that address will appear on the certifications discussed infra at pp. 57-58.

Note that the system will not under any circumstances disclose information about a second party's non-use of the system—the system will only disclose information about a second party's use of the system, and in that regard will only do so if the second party has, in fact, used the system to enter data and has authorized the system to make the disclosure in question. Thus, a second party cannot, by refusing use the system, try to indirectly use the system as a “signaling” device—he will not be able to prove via the system itself that he did not use it.

H.14 Manner in Which the System Receives Initial Data from the Second Party

As was noted within the Brief Summary of the Invention at paragraph [0049], supra at p. 32, if the second party elects to use the system, the second party will, upon going to the website that provides access to the system and entering his password, be directed to a private page on that website that is associated with the relevant account and where a copy of the relevant Terms Sheet appears. Consistent with the undertakings made within that Term Sheet, the second party may then enter data signifying the second party's agreement to accept the terms proposed by the first party provided that those terms are equal to or more favorable to the second party than the terms that the second party specifies within that data.

For example, in cases where, as within the example described supra at pp. 39-41, the underlying dispute is one in which the second party is seeking money from the first party, the second party may enter data signifying its willingness to accept the monetary amount referred to within the Term Sheet as x provided that x is greater than equal to a monetary amount specified by the second party within the data that the second party enters at that time.

### H.15 Manner in Which the System Compares the Data Entered by the Parties

As was noted within the Brief Summary of the Invention at paragraph [0050], supra at p. 32, in the event that the second party submits data as described above, the computerized system makes a determination as to whether or not the terms proposed by the first party are equal to or more favorable to the second party than the terms specified by the second party. For example, in cases where, as within the example described above, the underlying dispute is one in which the second party is seeking money from the first party, that data would consist of two monetary amounts, and the system would simply determine whether or not the amount specified by the first party was greater than or equal to the amount specified by the second party through basic, rudimentary computing. (Note that in such a case a determination by the system that the amount specified by the first party was equal to or greater than the amount specified by the second party would result in a settlement of the dispute for the amount specified by the first party. This fact would thereupon be disclosed by the system automatically to both parties via notice on the private pages of the website relating to that account, as well as by forwarding to each party at their respective addresses—in the preferred embodiment, via e-mail—a copy of a certification as described infra at pp. 57-58).

A similar rudimentary computerized process would serve to carry out the comparison in cases where the undisclosed term did not consist of a monetary amount but rather consisted of a numerical term or a proper noun, such as the name of a person or a place. In such contexts, the process that the second party goes through would be analogous to entering a password into a secure website in an effort to gain access to another level of that site: if the data that he enters falls within certain parameters, the case would settle, while in all other cases the data that he entered would be rejected. It will also be appreciated that such relatively simple technology can be used to allow the first party to specify multiple undisclosed terms: in such cases, the second party would have to enter data with respect to each of those terms Oust as a party may be required to enter both a user name and a password to enter a secured website) and, unless that data fell within certain parameters, the data would be rejected. (Note that such existing technology also allows for configurations of the system whereby, for example, a first party could designate multiple alternative terms as confidential terms, such as both a date and an amount of money, and designate that varying amounts of money would be acceptable, depending upon the data entered by the second party with respect to the date).

### H.16 Description of the Manner in Which the System Discloses the Outcome of the Data Comparison to the Second Party

As was noted within the Brief Summary of the Invention at paragraph [0051], supra at p. 32, if the system determines that the terms specified by the first party are not equal to or more favorable to the second party than the terms specified by the second party, then the system would (i) automatically disclose that determination to the second party on a page of the website that could only be accessed via the second party's password, and (ii) provide the second party with an opportunity to submit data signifying the second party's agreement to have the terms specified by the respective parties submitted to final-offer arbitration for a determination as to which terms were fairer.

Note that under the circumstances described above, the determination made by the system would not be disclosed by the system to the first party, nor would the system disclose to the first party whether or not the second party had used the system at all, unless the second party elected to proceed to arbitration (as discussed below in subsection H.18, infra at p. 55).

### H.17 Description of the Manner in Which the System Presents Options to and Receives Additional Data From the Second Party

Upon a determination by the system as described in the previous subsection, the system would, as noted within that subsection, disclose that determination to the second party and present him with various options. At a minimum, these options would consist of (i) an opportunity to enter data signifying his agreement to proceed to final-offer arbitration and, if he wished to proceed to final-offer arbitration, (ii) an opportunity to enter data (which he would have to enter if he wished to proceed to final-offer arbitration through the use of the system) signifying whether the outcome determined to be fairer within the final-offer arbitration would be (a) binding upon both parties, or (b) only binding upon the parties in the event that the second party won the arbitration (i.e., only binding if the final-offer arbitration resulted in a determination that the second party's proposal was fairer).

Note that it is possible to configure the system so that other, additional options are presented to the second party upon a determination by the system that the first party's proposed settlement terms are not equal to or more favorable to the second party than the second party's proposed settlement terms. For example, it would be possible to grant the second party an opportunity to enter data proposing alternative terms at that time, or to do this on a specified number of occasions, or to grant the second party an opportunity to enter data proposing alternative terms on each occasion that such a determination was made up to the deadline. See generally, with regard to this issue, the discussion at paragraph [0066]-[0067], supra at p. 42 (noting, inter alia, that the granting of those sorts of options does not constitute an element of the present invention but would under most circumstances serve to enhance the utility of any given embodiment of the present invention).

### H.18 Comment on Certain Disclosure and Confidentiality Issues Relating to an Election to Proceed to Final-Offer Arbitration

With regard to disclosure and confidentiality issues, it should here be noted that, if the second party enters data electing final-offer arbitration, he would at that same time be obliged to submit data explicitly authorizing the system to disclose the fact that he had done so to the first party. In the preferred embodiment, he would not be obliged to authorize the system to disclose which of the two options he had selected with respect to the binding nature of the arbitration, nor would he be obliged to authorize the system to disclose the settlement terms that he had proposed (e.g., y). However, the second party would have to disclose that term to the arbitrator for purpose of the final offer arbitration, and this could be done via use of one of the certificates issued by the system as discussed infra at pp. 57-58.

In other words, if the matter proceeds to final-offer arbitration, neither party will know or learn of the other's proposal with respect to the penultimate, undisclosed term unless (i) the other party voluntarily or by mutual agreement discloses that term, or (ii) the matter proceeds through an arbitration that is binding upon both parties (in which event the proposal that won would be disclosed by the arbitrator's award), or (iii) the second party had elected to only have the arbitration be binding in the event that he won, and he then won the arbitration (in which event the second party's proposal would be disclosed and be binding). If, alternatively, the second party had elected to only have the arbitration be binding in the event that he won and he then lost the arbitration, then there would be no settlement and the proposals made by the respective parties would not be disclosed (unless a party voluntarily or by mutual agreement made such a disclosure).

Similarly, in the preferred manner of using the system, the second party's election on whether or not to have the arbitration be binding in the event that the first party won would not be disclosed to the first party or the arbitrator until such time as the arbitrator had made its determination. This would negate the possibility that the arbitrator might take this fact into account in making his or her determination. However, this would necessitate that, after making the determination but before disclosing it to the parties, the arbitrator would need to be provided with a certificate from the system attesting to which option had been elected by the second party, because in cases where the first party won, the first party's proposal should not be disclosed to the second party unless that proposal was binding upon the second party (as otherwise the second party might use it as a starting point for demanding further concessions). In cases where the second party elects arbitration, this issue is addressed through the issuance of appropriate certifications by the system, as described below.

### H.19 Description of the Circumstances Under Which the System Issues Certifications

Recall that under various circumstances the system will generate and issue certifications to a party has used the system, attesting to the manner in which that party used the system and the results of that use (there are no circumstances under which a party that has not used the system will be issued any sort of certification concerning its non-use of the system). For example, in the event that, as of the deadline, the matter has not been settled through the use of the system and there was no election by the second party to proceed to arbitration, the system will automatically generate and send to the first party a certification attesting to those facts (under those circumstances, the system would not provide the first party with any information concerning any use or non-use of the system by the second party; the first party and any relevant Audience would be able to infer, however, that—to the extent that the second party used the system at all—he did not elect arbitration). The certificate issued to the first party under those circumstances will attest to the fact that the first party had proposed settlement terms, as referenced within the Term Sheet, but will not fully disclose all terms proposed by the first party (e.g., x) unless the first party requests that the certificate include that information.

In the event that the system makes a determination that the settlement proposal made by the first party was equal to or more favorable to the second party than the settlement proposal made by the second party through the use of the system, then the system will automatically generate and send certificates to each party concerning that party's use of the system and the results of that use. Under those circumstances, the “results” of that use would include the parties having each agreed to a settlement on the basis of the first party's proposed settlement terms, and those terms will be disclosed to the second party. However, under those circumstances, the system would not disclose the settlement terms proposed by the second party.

In the event that the second party elects arbitration, the system will generate and send to each party a certificate attesting to the manner in which that particular party used the system, which would include a disclosure of the actual settlement terms proposed by that party, and would also attest to the “results” of that use, i.e., that the parties had agreed to proceed to final-offer arbitration. Each party would then be able to submit its certificate to the arbitrator in furtherance of the final-offer arbitration. In addition, under those circumstances, a separate certificate will be generated and issued to the second party attesting to whether or not the second party had opted not to be bound by the arbitration unless he won. This certificate can be presented to the arbitrator by the second party following the time at which the arbitrator makes its determination of which party won, but prior to the arbitrator's disclosure of that determination. (In most cases it the first party will want to require that the arbitrator may not fully disclose the first party's settlement proposal unless the arbitrator determines that the first party has won and that the second party had agreed to be bound by that outcome).

Note that it would also be possible to configure the system so that the second party could—in the event that (i) he submitted a settlement proposal that did not result in a settlement and (ii) he did not elect to proceed to final-offer arbitration—be issued a certificate attesting to the manner in which he used the system, including the settlement terms that he proposed and the fact that he declined to proceed to final-offer arbitration. (For example, under the Fair Proposals System discussed supra at p.p. 27-29, a party that is invited to use the system and that makes a proposal that does not produce a resolution can obtain such a certification, as this enhances the incentive of the initiating party to make a reasonable proposal). However, it is respectfully submitted that, given the various features of the system that is described within this Disclosure, such a certificate would be of no use to a rational second party, and would in fact be adverse to the second party's own self-interests—in large part because of the fact that the first party had granted the second party an option to proceed to a final-offer arbitration process and to elect not to bound in the event that he did not win. There is, accordingly, no reason to include such a feature within any given configuration of the system described in this Disclosure.

### H.20 Ramifications Within the E-Commerce Field

Reputation-rating systems facilitate settlements. The problem is that they can also be used as a device for trying to extract payments or other benefits that are fundamentally unfair. And this, in turn, leads to a further problem—even where negative feedback is submitted for a legitimate purpose, a party whose reputation is adversely affected may believe or claim that it was submitted for purposes of extortion. Such claims are often accompanied by retaliatory feedback, by claims that the administrator of the site should take corrective action, and by unjustified criticism of the site and the reputation-rating system as a whole. These sorts of problems can be expected to grow as online markets expand. They can also be expected to increase radically as reputation ratings start to take on added significance, such as by being factored into the fees charged, or to the visibility provided, to a given party on a given e-commerce site.

The invention that is the subject of this Disclosure provides a solution to this set of problems. A party that has, justifiably or unjustifiably, been subjected to negative feedback adversely affecting her reputation does not need to submit to extortion, agree to an unfair settlement, or drag an administrator into the dispute in order to restore her reputation. Rather, she can do so by simply initiating use of the system described herein, i.e., by formulating and committing herself to a proposal and to a process that is fair. In this manner, reputation-rating systems will continue to facilitate settlements, but they will generate more accurate ratings, give rise to less criticism, and produce more outcomes that are indisputably fair.

### H.21 Ramifications With Respect to Conflicts Arising Outside of E-Commerce Field

Where two parties are involved in a dispute or bargaining process with respect to an amount of money, game-theoretic studies of sealed-bid mechanisms suggest that both parties would in many instances be better off if—instead of attempting to engage in traditional, communicative bargaining—they were to agree to enter into a symmetrical arrangement whereby each could confidentially propose a number to a neutral party, who could then compare those numbers to see whether they matched or crossed (in which event the matter would be resolved). See, e.g. Schelling (1960), at p. 20 (cited supra at p. 6—noting that this process could be carried out by a computing machine). For example, Babcock and Landeo (2004) describe a study wherein test subjects, using a symmetrical sealed-bid mechanism, achieved bargained solutions 69% of the time (as opposed to a 49% rate for test subjects that engaged in traditional, communicative bargaining; and with litigation costs that were 37% lower). Babcock, L. C. and Landeo, C. M. (2004). “Settlement Escrows: A Study of a Bilateral Bargaining Game.” Journal of Economic Behavior and Organization, Vol. 53, No. 3, pp. 401-417.

These studies also indicate that a mechanism that facilitates such independent valuations and that is properly designed and configured does more than simply increase settlements and reduce costs. It “generally leads to . . . payoffs that are more in line with the underlying merits of the case . . . ” Gertner and Miller (1995), p. 28 (cited supra at p. 45). In other words, the use of such mechanisms generally leads to outcomes that are more in line with what the community at large would view as a fair settlement in light of the circumstances of the case, the applicable law and the potential outcomes at trial. An explanation for this would be that such outcomes are, or become, “focal” in the sense that parties engaged in non-cooperative, non-communicative bargaining can each independently recognize such an outcome as a common solution to their tacit game, with the result that they will converge towards it as a deadline approaches. Shelling (1960), pp. 53-80, 270-271 (cited supra at p. 6).

The historical obstacle to the use of mechanisms as described by Schelling (1960), Gertner and Miller (1995) and Babcock and Landeo (2004) has not been that they don't work, but rather that their design and configuration has been such that parties have been reluctant to offer to use them prior to the eve of trial (at which point the vast majority of cases will settle anyway, with or without the use of a symmetrical sealed-bid system or mediation process. Alexander, J. C. (1999) (cited supra at p. 8); Spier, K. E. (1992) (cited supra at p. 19)). For example, and as was previously noted, a party may be reluctant to offer to use such a system because, if a party does so, its “adversary may infer that the offer or's case is weak. Therefore, neither party will suggest [such use], despite the fact that each would be better off if the [mechanism] was forced upon them.” Gertner and Miller (1995), p. 38 (cited supra at p. 45).

In considering the various features of the system described within this Disclosure, it will be observed that many of these features serve to address the historical obstacles to the use of more traditional bargaining mechanisms, such as mediation and symmetrical sealed-bid systems. For example, a first party that initiates the use of the system described in this Disclosure is not signaling weakness—she has, in effect, simply tendered a “take-it-or-leave-it” or “drop dead” offer to her adversary (doing so with a level of credibility that is historically unprecedented). She will, in effect, be expressing complete indifference to any alternative outcomes that her adversary might wish to have her consider, as the system will not disclose any such alternative proposals to her.

Similarly, and in contrast to mediation and traditional sealed-bid mechanisms, a party that is invited to utilize the system that is disclosed herein as a second party cannot justify a refusal to use that system—or a failure to put forth a fair proposal within the context of that use—by citing any of the standard excuses or professed concerns that parties typically cite with respect to such a process. Specifically, for the reasons noted within this Disclosure, the structure of the system described herein precludes the second party from rationally concluding, or from credibly arguing (i) that his use of the system might send a signal of weakness, i.e., of a willingness to consider compromise or to reconsider his publicly stated position with respect to the dispute (because his use is not disclosed unless he achieves a resolution that he has defined as acceptable); and (ii) that his failure to participate in the process, or to put forth a fair proposal, was justified by a concern that he might inadvertently propose, and thus wind up with, a resolution less favorable to him than the resolution proposed by the first party. Nor may he credibly profess concern that he might be treated unfairly if he elected to proceed to final-offer arbitration through the use of the system, because he could fully address any such purported concerns by simply opting to have the arbitration not be binding unless he won.

Each of the foregoing points becomes fully evident when one considers the various features of the system and the manner in which they interact with one another, as discussed in the foregoing sections of this Disclosure. A first party that uses the system allows an Audience—regardless of whether that Audience is fully informed or incapable of becoming even partially informed about the merits of the underlying dispute—to reasonably infer and order its affairs on the supposition that the first party has treated the second party in a fair manner with respect to the underlying dispute. The structure of the system deprives her adversary of any basis for taking issue with an Audience's conclusion that the first party has made such a demonstration. As was noted by Elihu Root on the eve of World War I with respect to Audiences that have been presented with such demonstrations: “theirs will be the vengeance and they will inflict the punishment.” Root, E. (1914) (cited supra at p. 6). As was noted by Schelling at the height of the Cold War: “One constrains the [adversary's] choice by constraining one's own behavior.” Schelling, T. C. (1960), at p. 160 (cited supra at p. 6).

### H.22 General Ramifications and Scope of the Invention

It will be appreciated that the computerized system that is the subject of this Disclosure provides a highly useable and easy to administer system whereby a party that is involved in a dispute may, by entering a very simple set of data, either secure a resolution of that dispute on terms that that party deems to be acceptable or allow that party to easily and credibly demonstrate to third parties that it has acted fairly in connection with that dispute. A working version of the System could be readily built or made from the information contained herein by any law firm, bank or other party with experience in the escrow field, and could easily be administered by such parties and used by anyone competent to engage in traditional escrow transactions.

While the foregoing description contains many specifications, they should not be construed as limitations of the scope of the invention, but rather as an exemplification of one preferred embodiment thereof. Many other variations are possible, such as the use of a telephonic, rather than a web-based, platform for the system, or such as by having the precise manner in which the System will be used in any given case dictated in a pre-existing agreement between the parties (i.e., an agreement that was entered into by the parties prior to the time at which the circumstances giving rise to the dispute arose, similar to an agreement containing an arbitration provision), or dictated by an entity to whose power both parties are subject, such as a sovereign entity, its court system, or an employer. Accordingly, the scope of the invention should be determined not by the embodiments described above, but by the appended claims and their legal equivalents.

The inventor claims:

1: A computer accessible medium containing instructions which when executed by a processor instruct the processor to perform the following steps for the conveyance of proposals with respect to the settlement of a dispute:
a) Receiving first information from a first party wherein first information contains at least in part data specifying a deadline and a set of terms under which first party would be willing to settle a dispute with a second party if said terms were accepted by second party prior to said deadline, and wherein first party signifies its agreement, if said terms are not accepted by said deadline, to submit said terms to final-offer arbitration for a determination as to whether said terms were fairer than an alternative set of terms that may be specified by second party prior to said deadline, and to allow second party to elect, prior to said arbitration, to have said determination only be binding upon the parties in the event that said second party loses said arbitration;
b) Holding first information in escrow up to said deadline;
c) Providing second party with an opportunity, up to said deadline, to submit second information wherein second information contains at least in part data signifying second party's agreement to settle said dispute based on the terms specified in first information provided that said terms are equal to or more favorable to second party than certain terms specified by second party within second information;
d) Upon receiving such second information prior to said deadline, determining third information as a function of first and second information wherein third information includes at least in part a determination of whether said terms specified within second information are equal to or less favorable to second party than the terms specified in first information.
e) Upon a determination that said terms specified in first information are not equal to or more favorable to second party than the terms specified in second information, disclosing that determination to second party and providing second party with an opportunity to submit fourth information prior to the deadline wherein fourth information contains at least in part data signifying second party's agreement to have said terms specified in second information and the terms specified in first information submitted to final-offer arbitration for a determination as to which terms were fairer, and which fourth information also includes at least in part data signifying an election by second party to have said determination only be binding upon the parties in the event that said second party wins said arbitration;
f) Upon the submission of fourth information, issuing certificates to each party that has entered data into the system attesting to the manner in which that party used the system and the results of that use;
g) In the event that such fourth information is not submitted, issuing a certificate to first party attesting to the manner in which the first party used the system and the results of said use; and
h) holding as confidential any information relating to either party's use of the system except to the extent that that party has authorized the system to disclose specific information about one or more aspects of that party's use of the system;
i) whereby a party that is involved in a dispute can either secure a resolution of that dispute on terms that that party deems to be acceptable or be in a position to easily and credibly demonstrate to third parties that it has acted fairly in connection with that dispute.

2: A system for facilitating the conveyance of proposals with respect to the settlement of a dispute comprising: a computer having a memory and a processor; and a computer-readable medium for generating software code, which, when said code is loaded into the memory and run by the processor, causes the processor to perform the steps of:
a) Receiving first information from a first party wherein first information contains at least in part data specifying a deadline and a set of terms under which first party would be willing to settle a dispute with a second party if said terms were accepted by second party prior to said deadline, and wherein first party signifies its agreement, if said terms are not accepted by said deadline, to submit said terms to final-offer arbitration for a determination as to whether said terms were fairer than an alternative set of terms that may be specified by second party prior to said deadline, and to allow second party to elect, prior to said arbitration, to have said determination only be binding upon the parties in the event that said second party loses said arbitration;
b) Holding first information in escrow up to said deadline;
c) Providing second party with an opportunity, up to said deadline, to submit second information wherein second information contains at least in part data signifying second party's agreement to settle said dispute based on the terms specified in first information provided that said terms are equal to or more favorable to second party than certain terms specified by second party within second information;
d) Upon receiving such second information prior to said deadline, determining third information as a function of first and second information wherein third information includes at least in part a determination of whether said terms specified within second information are equal to or less favorable to second party than the terms specified in first information.
e) Upon a determination that said terms specified in first information are not equal to or more favorable to second party than the terms specified in second information, disclosing that determination to second party and providing second party with an opportunity to submit fourth information prior to the deadline wherein fourth information contains at least in part data signifying second party's agreement to have said terms specified in second information and the terms specified in first information submitted to final-offer arbitration for a determination as to which terms were fairer, and which fourth information also includes at least in part data signifying an election by second party to have said determination only be binding upon the parties in the event that said second party wins said arbitration;
f) Upon the submission of fourth information, issuing certificates to each party that has entered data into the system attesting to the manner in which that party used the system and the results of that use;
g) In the event that such fourth information is not submitted, issuing a certificate to first party attesting to the manner in which the first party used the system and the results of said use; and
h) holding as confidential any information relating to either party's use of the system except to the extent that that party has authorized the system to disclose specific information about one or more aspects of that party's use of the system;
i) whereby a party that is involved in a dispute can either secure a resolution of that dispute on terms that that party deems to be acceptable or be in a position to easily and credibly demonstrate to third parties that it has acted fairly in connection with that dispute.

3: The computer accessible medium of claim 1 wherein the instructions are adapted to instruct the processor to allow said first information to include a designation of one or more terms as terms that should not be disclosed to the second party unless said third information includes a determination that said terms specified within said second information are equal to or less favorable to said second party than the terms specified in said first information.

4: The computer accessible medium of claim 2 wherein the instructions are adapted to instruct the processor to allow said first information to include a designation of one or more terms as terms that should not be disclosed to the second party unless said third information includes a determination that said terms specified within said second information are equal to or less favorable to said second party than the terms specified in said first information.

5: The computer accessible medium of claim 1 wherein the instructions are adapted to instruct the processor to determine third information at least in part based on whether a numerical value contained in first information is less than or equal to a numerical value contained in second information.

6: The computer accessible medium of claim 2 wherein the instructions are adapted to instruct the processor to determine third information at least in part based on whether a numerical value contained in first information is less than or equal to a numerical value contained in second information.

7: The computer accessible medium of claim 1 wherein the instructions are adapted to instruct the processor to determine third information at least in part based on whether a numerical value contained in first information is greater than or equal to a numerical value set for second information.

8: The computer accessible medium of claim 2 wherein the instructions are adapted to instruct the processor to determine third information at least in part based on whether a numerical value contained in first information is greater than or equal to a numerical value set for second information.

9: The computer accessible medium of claim 1 wherein the instructions are adapted to instruct the processor to hold the first information in escrow for a predetermined period of time.

10: The computer accessible medium of claim 2 wherein the instructions are adapted to instruct the processor to hold the first information in escrow for a predetermined period of time.

11: The computer accessible medium of claim 1 wherein the instructions are adapted to instruct the processor to notify second party that first information has been received and is being held in escrow.

12: The computer accessible medium of claim 2 wherein the instructions are adapted to instruct the processor to notify second party that first information has been received and is being held in escrow.

13: A system or method that comprises:
a) Receiving first information from a first party wherein first information contains at least in part data specifying a deadline and a set of terms under which first party would be willing to settle a dispute with a second party if said terms were accepted by second party prior to said deadline, and wherein first party signifies its agreement, if said terms are not accepted by said deadline, to submit said terms to final-offer arbitration for a determination as to whether said terms were fairer than an alternative set of terms that may be specified by second party prior to said deadline, and to allow second party to elect, prior to said arbitration, to have said determination only be binding upon the parties in the event that said second party loses said arbitration;
b) Holding first information in escrow up to said deadline;
c) Providing second party with an opportunity, up to said deadline, to submit second information wherein second information contains at least in part data signifying second party's agreement to settle said dispute based on the terms specified in first information provided that said terms are equal to or more favorable to second party than certain terms specified by second party within second information;
d) Upon receiving such second information prior to said deadline, determining third information as a function of first and second information wherein third information includes at least in part a determination of whether said terms specified within second information are equal to or less favorable to second party than the terms specified in first information.
e) Upon a determination that said terms specified in first information are not equal to or more favorable to second party than the terms specified in second information, disclosing that determination to second party and providing second party with an opportunity to submit fourth information prior to the deadline wherein fourth information contains at least in part data signifying second party's agreement to have said terms specified in second information and the terms specified in first information submitted to final-offer arbitration for a determination as to which terms were fairer, and which fourth information also includes at least in part data signifying an election by second party to have said determination only be binding upon the parties in the event that said second party wins said arbitration;
f) Upon the submission of fourth information, issuing certificates to each party that has entered data into the system attesting to the manner in which that party used the system and the results of that use;
g) In the event that such fourth information is not submitted, issuing a certificate to first party attesting to the manner in which the first party used the system and the results of said use; and
h) holding as confidential any information relating to either party's use of the system except to the extent that that party has authorized the system to disclose specific information about one or more aspects of that party's use of the system;
i) whereby a party that is involved in a dispute can either secure a resolution of that dispute on terms that that party deems to be acceptable or be in a position to easily and credibly demonstrate to third parties that it has acted fairly in connection with that dispute.

14: The method or system described in claim 13 wherein:
b) The system is accessible, and communications between the parties and the system may be conducted, via means of a global information network, including the internet, the world-wide web, or wireless or non-wireless telecommunication systems.

15: The method or system described in claim 13 wherein:
a) Said determinations and said disclosures are performed by an automated or computerized method.
